(19) United States
(12) Patent Application Publication
(10) Pub. No.: US 2007/0054216 A1
(43) Pub. Date: Mar. 8, 2007

(54) Near-infrared ray absorbing material and production method of the same

(75) Inventor: Takeshi Habu, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/511,471

(22) Filed: Aug. 29, 2006

(30) Foreign Application Priority Data
Sep. 2, 2005 (JP) JP2005-254549

(51) Int. Cl. G03C 1/00

(52) U.S. Cl. 430/270.1

(57) ABSTRACT

A method of producing a near-infrared ray absorbing material comprising the steps of: applying a coating liquid of a near-infrared ray absorbing layer comprising a near-infrared ray absorbing dye and a latex onto a support to form a coated layer; and drying the coated layer by heat to form a near-infrared ray absorbing layer, wherein the near-infrared ray absorbing layer absorbs not less than 60% of a total amount of near-infrared rays having wavelengths of 800 to 1000 nm.

This application is based on Japanese Patent Application No. 2005-254549 filed on Sep. 2, 2005 in Japanese Patent Office, the entire content of which is hereby incorporated by reference.

### FIELD OF THE INVENTION

The present invention relates to a near-infrared ray absorbing material to be used to the front surface of a plasma display panel (PDP), which is capable of absorbing near-infrared rays and transparent to visible light and a producing method thereof.

### BACKGROUND OF THE INVENTION

In the plasma display panel (PDP), light is emitted by exciting a phosphor by ultra-violet rays emitted from rare gas in a plasma state. On such the occasion, near-infrared rays are simultaneously emitted. Therefore, demand for cutting the emitted near-infrared of from 800 to 1,000 nm raises for preventing erroneous operation of an operating means such as a remote controller. The wavelength of near-infrared rays emitted from the plasma display is similar to that emitted from remote controllers such for domestic use apparatus such as televisions and room coolers, and those for specific business, industrial or communication use. Accordingly, the near-infrared rays obstruct the functions of apparatuses used around the display even though the influence is difference according to the apparatus. Therefore, the erroneous operation of the apparatuses arranged around the display is caused by the near-infrared rays emitted from the plasma display. For satisfying such the demand, a method of pasting a near-infrared rays absorbing film onto the front glass of the PDP is mainly applied since such the method is simple and advantageous in the cost.

However, deterioration of the near-infrared ray absorbing film caused by heat and ultra-violet rays from the PDP causes problems, and development of a heat resistive near-infrared ray absorbing dye and combination use of a UV absorbent having high absorption efficiency are tried as a countermeasure to such the problems. But the sufficient effect cannot be obtained yet. Though a coating method using a non-aqueous system is proposed because the presence of moisture greatly influences to the deterioration of the near-infrared ray absorbing dye, cf. Patent Document 1 for example, such the method has a shortcoming that the influence of remaining solvent is caused. A method in which a near-infrared ray absorbing layer is formed by a hydrophobic resin without solvent formed by polymerization of a monomer and a polymerization initiator in the presence of the dye is also proposed but this method is inferior in the productive efficiency since any coating method cannot be applied, cf. Patent Document 2 for example. A method is proposed in which the dye is dispersed in an aqueous medium in a particle state, cf. Patent Document 3 for example, but this method is inferior in the preservation ability of the dye since the dye is strongly influenced by the moisture. Moreover, a method of coating a gelatin dispersing aqueous system which is advantageous for coating a thin layer at high speed and high productive efficiency is proposed, cf. Patent Document 4 for example, but it is present status that the deterioration of the near-infrared ray absorbing dye during the storage at high temperature and high humidity cannot be avoided because the gelatin has moisture holding ability.

As above-described, high productive efficiency can be obtained by the aqueous system coating method in which the near-infrared ray absorbing dye is dispersed in gelatin having high dispersing ability but the layer coated by such the method has a shortcoming that the layer is low in the storage ability. The non-aqueous method in which the dye is coated in a state of dispersed in a resin soluble in an organic solvent poses problems of unhealthy working environment caused by the volatized organic solvent and deterioration of the dye by the organic solvent volatized after production.

Patent Document 1: Japanese Patent Publication Open to Public Inspection (hereafter referred to as JP-A) No. 10-186127 (Paragraph 0059)

Patent Document 2: JP-A No. 11-109126 (Paragraphs 0042 and 0043)

Patent Document 3: JP-A No. 11-109560 (Paragraph 0105)

Patent Document 4: JP-A No. 10-333295 (Paragraphs 0071-0131)

### SUMMARY OF THE INVENTION

An object of the present invention is to provide a production method of a near-infrared ray absorbing material which has high near-infrared ray absorbing ability and high productive efficiency and high durability.

One of the aspects of the present invention to achieve the above object is a method of producing a near-infrared ray absorbing material comprising the steps of: applying a coating liquid of a near-infrared ray absorbing layer comprising a near-infrared ray absorbing dye and a latex onto a support to form a coated layer; and drying the coated layer by heat to form a near-infrared ray absorbing layer, wherein the near-infrared ray absorbing layer absorbs not less than 60% of a total amount of near-infrared rays having wavelengths of 800 to 1000 nm.

### DESCRIPTION OF THE PREFERRED EMBODIMENTS

The object of the present invention can be attained by the following structures.

(1) A method of producing a near-infrared ray absorbing material comprising the steps of:

applying a coating liquid of a near-infrared ray absorbing layer comprising a near-infrared ray absorbing dye and a latex onto a support to form a coated layer; and

drying the coated layer by heat to form a near-infrared ray absorbing layer,

wherein the near-infrared ray absorbing layer absorbs not less than 60% of a total amount of near-infrared rays having wavelengths of 800 to 1000 nm.

(2) The method of Item (1), wherein the near-infrared ray absorbing layer absorbs not less than 80% of the total amount of near-infrared rays having wavelengths of 800 to 1000 nm.

(3) The method of Item (1) or (2), wherein the latex is selected from the group consisting of an acryl resin, a styrene resin, a urethane resin and a vinyl resin.

(4) The method of any one of Items (1) to (3), wherein the coating liquid comprises:

a solvent containing water in an amount of not less than 30 weight % based on the total weight of the solvent; and

a binder containing a latex in an amount of not less than 30 weight % based on the total weight of the binder,

wherein an equilibrium moisture content in the binder is not more than 3% by weight at a condition of 25° C. and 55% relative humidity.

(5) The method of any one of Items (1) to (3), wherein the coating liquid comprises:

a solvent containing water in an amount of not less than 30 weight % based on the total weight of the solvent; and

a binder containing a latex in an amount of not less than 60 weight % based on the total weight of the binder,

wherein an equilibrium moisture content in the binder is not more than 1 weight % at a condition of 25° C. and 55% relative humidity.

(6) The method of any one of Items (1) to (5), wherein the near-infrared ray absorbing material comprises a near-infrared ray absorbing dye selected from the group consisting of a diimmonium compound, a nickel dithiol compound, a phthalocyanine compound and a squalium compound.

(7) The method of Item (6), wherein the near-infrared ray absorbing dye is the squalium compound.

(8) A near-infrared ray absorbing material produced by the method of any one of Items (1) to (7).

(9) The near-infrared ray absorbing material of Item (8), wherein

the near-infrared ray absorbing material comprises 2 or more constitution layers; and

one of the constituting layers comprises a UV absorbent.

(10) The near-infrared ray absorbing material of Item (9), wherein

a bottom layer of the constitution layers is an antistatic layer comprising a metal oxide; and

a surface resistance of the antistatic layer is 10⁶ to 10¹² ohm/sq.

(11) The near-infrared ray absorbing material of any one of Items (8) to (10), wherein

the near-infrared ray absorbing material has a function layer on a surface of the support opposite to the surface on which the near-infrared ray absorbing layer is provided; and the function layer is selected from the group consisting of an antireflection layer, a hard coat layer, an adhesive layer and an electromagnetic radiation absorbing layer.

The production method of a near-infrared ray absorbing material which has high near-infrared ray absorbing ability and high productive efficiency and high durability can be provided by the present invention.

The present invention is described in detail below. First, the production method of the near-infrared ray absorbing material is described.

The near-infrared ray absorbing layer to be used in the present invention is prepared by coating a near-infrared ray absorbing layer coating liquid containing a near-infrared ray absorbing dye and a latex on the support and drying by heat to form the layer. The near-infrared ray absorbing layer of the present invention preferably absorbs not less than 60%, more preferably absorbs not less than 80% of the total amount of near-infrared rays having wavelengths of 800 to 1000 nm. When the absorbing ratio is less than 60%, malfunction may occur in a commonly used remote-control system of such as home electric appliances. The drying is usually performed at a temperature of from room temperature to 100° C. The latex of the present invention is comprised of the resin stably dispersed in an aqueous medium. Hitherto, “latex” has been used as the name of white emulsion spa collected from gum tree, but “a dispersion containing an aqueous medium and a polymer stably dispersed in the aqueous medium”, including an aqueous dispersion of a synthesized polymer, has been referred to as “latex” after the appearance of polymer synthesized by emulsion polymerization. Therefore, such the name is used in the present invention. Examples of the water-dispersible resin include poly(vinylidene chloride), vinylidene chloride-acrylic acid copolymer, vinylidene chloride-itaconic acid copolymer, sodium polyacrylate, poly(ethylene oxide), acrylic amide-acrylate copolymer, styrene-maleic anhydride copolymer, acrylonitrile-butadiene copolymer and vinyl chloride-vinyl acetate copolymer, and styrene-butadiene type and styrene-isoprene type copolymer prepared by adding a little amount of one or more kinds of monomer containing a carboxylic group such as acrylic acid, methacrylic acid, itaconic acid and maleic acid are used according to circumstances.

Latexes are widely used for the binder in the aqueous coating system; among them the latex capable of raising the moisture resistivity is preferable for the binder in the present invention. The using amount of the binder for raising the moisture resistivity is decided considering the coating suitability and is preferably large from the viewpoint of the moisture resistivity; the amount is preferably from 30 to 100%, more preferably from 60 to 100%, based on the whole amount of the binder. Such the resin is available on the market. Examples of a latex preferably used in the present invention include an acryl resin, a styrene resin, a urethane resin and a vinyl resin.

As examples of styrene resin, various kinds of styrene-butadiene copolymer such as those each having industrial unified number of #1500, #1502, #1507, #1712 or #1778 can be used which are supplied under commercial names of Sumitomo SBR Latex (Sumitomo Chemical Co., Ltd.), JSR Latex (JSR Co., Ltd.), and Nipol Latex (Nihon Zeon Co., Ltd.).

The styrene-butadiene copolymer is preferably has a copolymerization ratio in weight of styrene and butadiene of from 1/90 to 90/10, and more preferably from 20/80 to 60/40. One so called high styrene latex having a ratio of from 60/40 to 90/10 is preferably used combined with the resin having low styrene content of from 10/90 to 30/70 for raising the anti-damaging ability and physical strength. The mixing ratio in weight is preferably from 20/80 to 80/20.

As the high styrene latex, JSR 0051 and 0061, each manufactured by JSR Co., Ltd., and Nipol 2002, 2057 and 2007, each manufactured by Nihon Zeon Co., Ltd., each available on the market can be used. As the latex having low styrene content, usually used ones other than the above-described high styrene latexes such as JSR #1500, #1502, #1507, #1712 and #1778 are usable.

As the acryl resin, usually known aryl type latexes such as Nipol NR31, AR32 and Hycar 4021, each manufactured by Nihon Zeon Co., are usable.

A polymer or copolymer derived from the following monomers can be used as the acryl resin. In the followings, “(meth)acryloyl group” means “acryloyl group or methacryloyl group”.

Examples of the monomer having one (meth)acryloyl group in the molecular thereof include a methacrylate of an aliphatic alcohol such as methyl methacrylate, ethyl methacrylate and octyl methacrylate, an acrylate of an aliphatic alcohol such as methyl acrylate, ethyl acrylate, butyl acrylate and octyl acrylate, an acrylate of an alicyclic alcohol such as cyclohexyl acrylate and cyclohexyl methyl acrylate, a methacrylate of an alicyclic alcohol such as cyclohexyl methacrylate and cyclohexyl methyl methacrylate, an acrylate containing an aromatic group such as phenyl acrylate, 4-bromophenyl acrylate and benzyl acrylate, a methacrylate containing an aromatic group such as phenyl methacrylate, 4-chlorophenyl methacrylate and benzyl methacrylate, and a hydroxyalkyl ester of acrylic acid or methacrylic acid such as 2-hydroxyethyl acrylate and 2-hydroxyethyl methacrylate.

Examples of monomer having two or more (meth)acryloyl group in the molecule thereof include a diacrylate such as ethylene glycol diacrylate, propylene glycol diacrylate, diethylene glycol diacrylate, 1,3-diacryloxy-2-propanol and poly(ethylene glycol) diacrylate, a dimethacrylate such as ethylene glycol dimethacrylate, propylene glycol dimethacrylate, diethylene glycol dimethacrylate, poly(ethylene glycol) dimethacrylate, 1,3-dimethacryloxy-2-propanol, a triacrylate such as glycerol triacrylate and trimethylolpropane triacrylate, and a trimethacrylate such as glycerol triacrylate and trimethylolpropane trimethacrylate.

Examples of the styrene resin include a homopolymer or copolymer with another monomer of an alkylstyrene monomer such as methyl styrene, ethylstyrene, propylstyrene, butylstyrene, hexylstyrene, heptylstyrene, octylstyrene, dimethylstyrene, trimethylstyrene, diethylstyrene and triethylstyrene, a halogenostyrene monomer such as fluorostyrene, chlorostyrene, bromostyrene, iodostyrene and dibromostyrene, a nitrostyrene monomer, an acetylstyrene monomer and a methoxystyrene monomer.

The vinyl resin is a polymer including a constituting unit of a monomer such as vinylpyridine, vinylpyrrolidone, vinylcarbazole, vinyl acetate, acrylonitrile, a vinyl or vinylidene halide such as vinyl chloride, vinyl bromide, vinylidene chloride and vinylidene bromide. A monomer having two or more vinyl groups may be contained as the constituting unit. Examples of such the monomer include a conjugate diene monomer such as divinylbenzene and chloroprene, divinyl-isoprene adipate, divinylsulfone, triethylene glycol divinyl ether and 1,4-cyclohexane dimethanol divinyl ether.

These monomers can be emulsion polymerized as above-mentioned. Water-soluble polymerization initiators can optionally used for the emulsion polymerization. Example of the water-soluble polymerization initiator include 2,2′-azobis(2-methylpropioneamidine) dihydrochloride, 4,4′-azobis(4-cyanovaleric acid), 2′-azobis[2-(2-imidazoline-2-yl)-propane]dihydrochloride, 2,2′-azobis[2-(5-methyl-2-imidazoline-2-yl)propane]dihydrochloride and 2,2′-azobisisobutylamide dehydrate. The using amount of the water-soluble polymerization initiator is preferably from 0.001 to 0.5 mole % of the whole monomer.

A dispersing agent is suitably used in the emulsion polymerization for stabilizing the polymerization system. For the dispersion stabilizer or dispersing agent, for example, poly(vinyl alcohol), poly(vinyl pyrrolidone), polyacrylamide, polymethacrylamide, a hydroxyalkyl acrylate polymer, a hydroxyalkyl methacrylate polymer, poly(acrylic acid) and its salt, poly(methacrylic acid) and its salt, ethylene-acrylic acid copolymer and its salt, ethylene-methacrylic acid copolymer and its salt, styrene-acrylic acid and its salt, styrene-methacrylic acid and its salt, polyethyleneimine, poly(alkylene glycol), poly(alkylene oxide), methylol-modified polyamide, water-soluble melamine resin, water-soluble phenol resin, water-soluble urea resin, casein, gelatin, carboxymethyl cellulose, methyl cellulose, hydroxyalkyl cellulose, carboxymethyl starch, cationized starch, dextrin, alginic acid and its salt, carrageenan, gellan gum, locust bean gum, gum arabic, traganth gum, glucomannan, zalepmannan, gur gum and a botanic mucus are usable singly or in combination. The dispersing agent is preferably used in an amount of from 0.01 to 20% by weight of the whole amount of the monomer or the resin to be dispersed.

Any of an anionic surfactant, a cationic surfactant, an amphoteric surfactant and a nonionic surfactant may be used for the emulsion polymerization without any limitation as long as it does not give any bad influence to the polymerization reaction. Examples of the surfactant include sodium salt of an alkylbenzenesulfonate, sodium salt of a higher alcohol sulfate, sodium salt of a higher α-olefinsulfonated compound, a higher fatty acid salt, sodium salt of a higher alkylphenolalkylene oxide sulfonic acid, a higher alkylamine salt, a higher alkyltrimethylammonium salt, a higher alkylpyridinium salt, a higher acylaminomethylpyridinium salt, a higher acyloxymethylpyridinium salt, an N,N-dioxyethyene-N-higher-alkylamine salt, a higher alkylpolyethylenepolyamine salt, a trimethyl higher alkylaniline sulfate, a trimethyl higher alkylbenzylammonium salt, a higher alcohol ethylene oxide adduct, a higher alkylphenol ethylene oxide adduct, a higher fatty acid ethylene oxide adduct, a higher alkylamine ethylene oxide adduct, a higher fatty acid amine ethylene oxide adduct, a higher fatty acid ester of glycerol, a higher fatty acid ester of pentaerythrytol, a higher fatty acid ester of sorbitol and sorbitan and an ethylene oxide adduct thereof, a higher fatty acid ester of sucrose, a higher alkyl ether of a polyol, a higher fatty acid amide of an alkanolamine, an amino acid type amphoteric surfactant and a betaine type amphoteric surfactant; they may be used singly or in combination. The using amount of the surfactant is preferably from 0.01 to 20% by weight of the whole amount of the monomer or the resin to be dispersed.

The latexes relating to the present invention are described in “Synthesized Resin Emulsion” edited by T. Okuda and H. Inagaki, Published by Koubunshi Kankoukai, 1978, “Application of Synthesized Latex” edited by T. Sugimura, Y. Kataoka, S. Suzuki and K. Kasahara, published by Koubunshi Kankoukai, 1993, and S. Muroi, “Chemistry of Synthesized Latex” published by Koubunshi Kankoukai, 1970. The average diameter of the dispersed resin particles of the latex is preferably from 1 to 500 nm, and more preferably from 5 to 100 nm. There is no limitation to the size distribution of particles, and the latex having wide particle size distribution and that having monodisperse distribution are usable.

The latex to be used in the present invention may be not only one having a usual uniform structure but also one having a core/shell structure. In such the case, it is preferable sometimes that the core and the shell are different from each other in the glass transition point.

The lowest film forming temperature (MFT) of the latex is preferably from −30° C. to 90° C., and more preferably from 0° C. to 70° C. A film formation assisting agent may be added for controlling the lowest film forming temperature. The film formation assisting agent, also so called a plasticizer, is an organic compound, usually an organic solvent, capable of lowering the lowest film forming temperature, which is described in the forgoing S. Muroi, “Chemistry of Synthesized Latex”.

The durability and the weather resistivity of the layer can be raised when the equilibrium moisture content of the latex after formation of the near-infrared ray absorbing layer at 25° C. and 55% of RH is not more than 3%, and more preferably not more than 1%. The lowest equilibrium moisture content is not specifically limited, but is preferably about 0.01%, and more preferably about 0.03%, by weight, though the lowest equilibrium moisture is not specifically limited. “Koubunshi Kougaku Kouza 14, Koubunshi Zairyou Shiken Hou”, edited by The Society of Polymer Science, Japan, published by Chijin Shokan, can be referred about the definition and the measuring method of the equilibrium moisture content. The measurement can be practically performed as described in the later-described Examples.

In the near-infrared ray absorbing layer of the present invention, the polymer derived from the latex accounts for not less than 30% by weight of the whole binder, and the ratio of the polymer of the latex is preferably not less than 60% by weight.

A hydrophilic polymer such as gelatin, poly(vinyl alcohol), methyl cellulose, hydroxypropyl cellulose, carboxymethyl cellulose and hydroxypropyl cellulose may be added to the near-infrared ray absorbing layer within the ratio of not more than 60% by weight of the whole binder. The adding amount of the hydrophilic polymer is preferably not more than 40% by weight of the whole binder. Examples of the poly(vinyl alcohol) (PVA) usable in the near-infrared ray absorbing layer of the present invention or a layer adjacent thereto are as follows.

Examples of saponified poly(vinyl alcohol) include PVA-124H having a PVA content of 93.5% by weight, saponification degree of 99.6±0.3 mole %, sodium acetate content of 1.85% by weight, volatile substance content of 5.0% by weight, viscosity of a solution of a concentration of 4% by weight at 20° C. of 61.0±6.0 CPS, PVA-CS having a PVA content of 94.0 by weight, saponification degree of 97.5±0.5 mole %, sodium acetate content of 1.0% by weight, volatile substance content of 5.0% by weight, viscosity of a solution of a concentration of 4% by weight at 20° C. of 27.5±3.0 CPS, PVA-CST having a PVA content of 94.0 by weight, saponification degree of 96.0±0.5 mole %, sodium acetate content of 1.0% by weight, volatile substance content of 5.0% by weight, viscosity of a solution of a concentration of 4% by weight at 20° C. of 27.0±3.0 CPS, PVA-HC having a PVA content of 90.0 by weight, saponification degree of not less than 99.85 mole %, sodium acetate content of 2.5% by weight, volatile substance content of 8.5% by weight, viscosity of a solution of a concentration of 4% by weight at 20° C. of 25.0±3.5 CPS; the above names of the compounds are each the trade name of Kuraray Co., Ltd. The pH of the coating liquid of the near-infrared ray absorbing layer and the adjacent layer is preferably from 5.0 to 7.8, and specifically preferably from 5.5 to 7.2.

The near-infrared ray absorbing layer of the present invention is formed by coating and drying the aqueous coating liquid. Here, the term of “aqueous” means that water accounts for 30% by weight or more of the solvent or the dispersing medium. For the ingredient of the coating liquid other than water, a water permissible organic solvent such as methanol, ethanol, isopropanol, methyl cellosolve, ethyl cellosolve, dimethyl formamide and ethyl acetate can be used.

Examples of the solvent composition are as follows: water/methanol=90/10, water/methanol=70/30, water/ethanol=90/10, water/isopropanol=90/10, water/dimethyl formamide=95/5, water/methanol/dimethyl formamide=80/15/5 and water/methanol/dimethyl formamide=90/5/5 by weight.

The whole amount of the binder per one near-infrared ray absorbing layer is preferably 0.2 to 30 g/m² and more preferably from 1 to 15 g/m². The thickness of the one near-infrared ray absorbing layer is preferably 0.3 to 50 μm and more preferably from 1.5 to 30 μm.

The latex of the present invention is used singly or in combination with gelatin. The content of gelatin is preferably as small as possible when the latex is used with gelatin. When the content of gelatin is large, the deterioration in the moisture resistivity becomes larger and when the content is too small, the uniformity of the coated layer is difficultly obtained. Therefore, the content of gelatin is preferably not more than 50% of the latex resin.

The near-infrared ray absorbing dye may be added to the latex liquid in a form of aqueous solution when the dye is water-soluble and in a form of solution in a water permissible organic solvent such as an alcohol, an ester and an ether. When the dye is insoluble in such the organic solvent, it can be added in a form of particle having a size of from 0.01 to 10 μm by dispersing the dye by a ball mill, a san mill, a beads mill or a jet mill. For dispersing the dye into the particle form, usual solid dispersion method can be suitably applied. Desired particle size can be obtained by using a dispersing machine such as a ball mill, a planet rotating ball mill, a vibration ball mill and a jet mill. The stability after dispersion can be improved by using a surfactant on the occasion of the dispersion.

Examples of the dispersing apparatus suitable for the present invention include Microfluidizer M-110S-EH with G10Z interaction chamber, M-110Y with H10Z interaction chamber, M-140K with G10Z interaction chamber, HC-5000 with L30Z or H230Z interaction chamber and HC-8000 with E230Z or L30Z interaction chamber, each manufactured by Microfluidex International Corp. The dispersion of near-infrared ray absorbing dye suitable for the present invention can be obtained by the use of these apparatuses in which an aqueous dispersion of the near-infrared ray absorbing dye is injected by a high pressure pump into the piping of the apparatus and a designated pressure is generated by passing the dispersion through a fine slit provided in the pipe and then the pressure applied to the dispersion is suddenly dropped by instantaneously restoring the pressure in the pipe to atmosphere pressure to disperse the dye particle. The dispersion is preferably subjected to a pre-dispersing treatment before the dispersing treatment. For pre-dispersing, known dispersing means such as a high-speed mixer, a homogenizer, a high-speed impact mill, a bunbury mixer, a homomixer, a kneader, a ball mill, a vibration ball mill, a planet ball mill, an attriter, a sand mill, a beads mill, a colloid mill, a jet mill, a roller mill, a tron mill and a high speed stone mill can be applied. Other than the mechanical means, the dye can be made to particles by roughly dispersed by controlling the pH value and then varying the pH value in the presence of a surfactant. In such the case, an organic solvent may be used as the medium for pre-dispersion; the solvent is usually removed after the particle formation.

In the dispersing process of the near-infrared ray absorbing dye, the dye can be dispersed into a desired particle size by controlling the flowing rate, the pressure difference on the occasion of the pressure dropping and the repeating number of the treatment and a flowing rate of from 200 m/second to 600 m/second and a pressure difference on the occasion of the pressure dropping of from 900 to 3,000 kg/cm² are preferable, and a flowing rate of from 300 m/second to 600 m/second and a pressure difference on the occasion of the pressure dropping of from 1,500 to 3,000 kg/cm² are more preferable from the viewpoint of the particle size. The repeating number of the treatment can be optionally decided according to necessity, and usually a time of from 1 to 10 is selected and from 1 to 3 times is selected from the viewpoint of productive efficiency. It is undesirable from the viewpoint of dispersion to raise the temperature of the aqueous dispersion under the high pressure, and the particle size tends to be grown under a high temperature exceeding 90° C. Consequently, it is preferable that a cooling process is provided in the process before applying the high pressure and high flowing rate, the process after dropping the pressure or both of these processes so as to keep the temperature of the dispersion within the range of from 5 to 90° C., more preferably from 5 to 80° C., further preferably from 5 to 65° C., by the cooling process. Particularly, the provision of the cooling process is advantageous when the dispersing is carried out at a high pressure within the range of from 1,500 to 3,000 kg/cm². The cooling means can be optionally selected from a double pipe heat exchanger, a double pipe heat exchanged having a static mixer, a multi-pipe heat exchanger and a helical pipe heat exchanger according to the necessary heat exchanging capacity. The diameter, wall thickness and material of the pipe can be suitably selected considering the applied pressure for raising the heat exchanging efficiency. As the cooling medium to be used for the cooling means, well water of 20° C., water cooled by from 5 to 10° C. by a freezing machine or ethylene glycol/water cooling medium of −30° C. can be used according to necessity.

In the dispersing operation, the near-infrared ray absorbing dye is preferably dispersed in the presence of a water-soluble dispersing agent or dispersion assisting agent. For the dispersing assisting agent, for example, a synthesized anionic polymer such as polyacrylic acid, a acrylic acid copolymer, a maleic acid copolymer, a maleic acid monoester copolymer and an acrylomethylsulfonic acid copolymer, a semi-synthesized anionic polymer such as carboxymethyl starch and carboxymethyl cellulose, an anionic polymer such as alginic acid and pectic acid, the compound described in JP-A No. 7-350753, known anionic, nonionic and cationic surfactants, a known polymer such as poly(vinyl alcohol), poly(vinyl pyrrolidone), carboxymethyl cellulose, hydroxypropyl cellulose, hydroxypropyl cellulose and hydroxypropylmethyl cellulose, and a natural polymer compound such as gelatin can be used and polyvinyl alcohols and water-soluble cellulose derivatives are particularly preferable. The dispersing assisting agent is usually charged into the dispersion apparatus in a form of slurry prepared by mixing with the powder or wet cake of near-infrared ray absorbing dye before the dispersing, but it is also arrowed to prepare the powder or wet cake of the near-infrared ray absorbing dye by previously mixing with the dye and subjected to a heat treatment or a solvent treatment. The pH may be controlled by a suitable pH controlling agent before, after or during the dispersing treatment. Other than the mechanical means, the dye can be made to particles by roughly dispersed by controlling the pH value and then varying the pH value in the presence of a surfactant. In such the case, an organic solvent may be used as the medium for pre-dispersion; the solvent is usually removed after the particle formation.

Thus prepared dispersion can be stored while stirring or in a high viscous state by a hydrophilic colloid, for example, in a jelled state by the use of gelatin, for preventing precipitation of the particle during the storage. A preservative may be added for preventing propagation of bacteria during the storage. The near-infrared ray absorbing dye particle dispersion to be used in the present invention comprises at least the near-infrared ray absorbing dye and water. Though the ratio of the near-infrared ray absorbing dye is not specifically limited, the ratio of the near-infrared ray absorbing dye to the whole dispersion is preferably from 5 to 50% by weight, and particularly preferably from 10 to 30% by weight. Though the foregoing dispersing assisting agent is preferably used, and the amount is preferably as small as possible within the range suitable for making minimum the particle size. The amount is preferably from 0.5 to 30%, and more preferably from 1 to 15%, by weight to the near-infrared ray absorbing dye. In the present invention, the near-infrared ray absorbing material can be produced by mixing the aqueous dispersion of the near-infrared ray absorbing dye and an aqueous dispersion of a UV absorbent. The ratio of the near-infrared ray absorbing dye to the UV absorbent can be decided according to the purpose of the use, and the ratio is preferably within the range of from 0.01 to 30 mole %, more preferably from 0.1 to 10 mole % and particularly from 0.5 to 5 mole % The mixing of two or more kinds of the near-infrared ray absorbing dye and two or more kinds of the UV absorbent is arrowed without any limitation.

When the near-infrared ray absorbing layer is provided, it is suitable to provide an adhesive layer, an antistatic layer and the near-infrared ray absorbing layer on the support in this order. The adhesive layer can be formed by coating a layer of from 0.1 to 1 μm of a vinylidene chloride copolymer or a styrene-glycidyl acrylate copolymer on a corona discharge treated support, after that the antistatic layer can be formed by coating a layer of gelatin, acryl or methacryl polymer or non-acryl polymer each containing a tin oxide or vanadium pentaoxide particle each doped with indium or phosphor and having an average particle diameter of from 0.01 to 1 μm. The antistatic layer can be also formed by coating a styrenesulfonic acid-maleic acid copolymer containing aziridine or carbonyl reactive type crosslinking agent. The near-infrared ray absorbing layer is formed by providing a dye layer on the antistatic layer. Colloidal silica, composite colloidal silica composed of colloidal silica covered with a methacrylate polymer, an acrylate polymer, or a non-acryl polymer such as a styrene polymer and an acrylamide polymer, inorganic or composite filler for stabilizing the dimension, silica and matting agent of poly(methyl methacrylate) for preventing the adhesion, and a silicone type slipping agent and a peeling agent can be added to the near-infrared ray absorbing layer.

The transparency of the front panel in the wavelength range of from 820 to 1,000 nm necessary for absorbing near-infrared rays of 820 nm, 850 to 900 nm and 950 to 1,000 nm emitted from the plasma display is preferably not less than 30%. The transparency at the visible ray region is lowered when the transparence at the near-infrared ray region is too low. Therefore, the transparency in the range of from 500 to 620 nm, the central portion of visible light, is preferably not less than 45% additionally to the above transparency at the near-infrared region. The transparency in the range of from 500 to 620 nm is more preferably not less than 50%. It is particularly preferable that the transparency at 450 nm, which is blue light region emitted from the plasma display panel, is not less than 45% additionally to the foregoing conditions. Moreover, it is particularly preferable to give an anti-reflection ability to the transparent film because the reflection of the exterior light is lowered and the transparency of the visible light is raised by the provision of the anti-reflecting ability to the transparent film. These properties may be provided to the transparent and electroconductive film or by laminating a film having such the properties on one or both sides of the film.

Concrete examples of the near-infrared ray absorbing dye include a polymethine type, a phthalocyanine type, a naphthalocyanine type, a metal complex type, an ammonium type, an immonium type, a diimmonium type, an anthraquinone type, a dithiol metal complex type, a naphthoquinone type, an indolphenol type, an azo type and a triarllylmethane type compound. Effects of heat ray absorption and noise prevention are principally required to the near-infrared ray absorbing ability of the optical filter for PDP. For obtaining such the effects, near-infrared ray absorbing dyes having the maximum absorption wavelength within the range of from 750 to 1,100 nm are preferable, and the metal complex type, aminium type, phthalocyanine type, diimmonium type and squarium type compounds are particularly preferable.

The maximum absorption wavelength of known nickel dithiol complex type compounds or fluorinated phthalocyanine type compounds is within the range of from 700 to 900 nm. Consequently, on the occasion of practical use, suitable near-infrared absorbing effect can be obtained by using such the dye together with the aminium compound, particularly a diimmonium compound, having the maximum absorption at longer wavelength region.

The diimonium compound is represented by the following Formula 1.

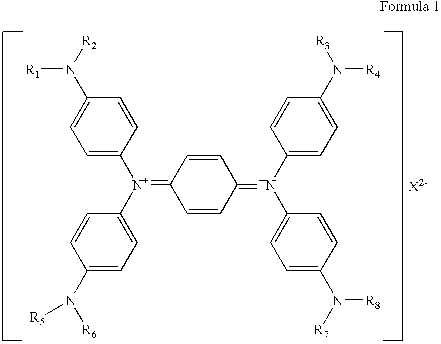

In Formula 1, R₁ through R₈ are each independently a hydrogen atom, an alkyl group, a substituted alkyl group, a cycloalkyl group, an alkenyl group, an aralkyl group or a substituted aralkyl group; they may have straight chain or branched chain. They may be the same or different. X is an anion.

The alkyl group, substituted alkyl group, cyclic alkyl group, alkenyl group, aralkyl group and substituted aralkyl group represented by R₁ through R₈ are as follows.

Examples of the alkyl group include a methyl group, an ethyl group, an n-propyl group, an iso-propyl group, an n-butyl group, an-iso-butyl group, a t-butyl group, an iso-pentyl group, an n-hexyl group and an n-octyl group; an alkyl group having 1 to 10 carbon atoms is preferable. Examples of the substituted alkyl group include a 2-hydroxyethyl group, a 3-hydroxypropyl group, a 4-hydroxybutyl group, a 2-acetoxyethyl group, a 3-carboxyporopyl group, a 3-carboxypropyl group, a 2-sulfoethyl group, a 3-sulfopropyl group, a 4-sulfobutyl group, a 3-sulfatebutyl group, an N-(methylsulfonyl)-carbamylethyl group, a 3-(acetylsulfamyl)propyl group, a 4-(acetylsulfamyl)butyl group, a cyanomethyl group, a 2-cyanoethyl group, a 3-cyanopropyl group, a 2-cyanopropyl group, a 4-cyanobutyl group, a 3-cyanobutyl group, a 2-cyanobutyl group, a 5-cyanopentyl group, a 4-cyanopentyl group, a 3-cyanopentyl, a 2-cyanopentyl group, a 6-cyanohexyl group, a 5-cyanohexyl group, a 4-cyanohexyl group, a 3-cyanohexyl group and a 2-cyanohexyl group. Examples of the cyclic alkyl group include a cyclohexyl group, and those of the alkenyl group include a vinyl group, an allyl group and a propenyl group. Examples of the aralkyl group include a benzyl group, a phenetyl group, a α-naphthylmethyl group and a β-naphthylmethyl group, and those of the substituted aralkyl group include a carboxybenzyl group, a sulfobenzyl group and a hydroxybenzyl group. Among the groups represented by R₁ through R₈, an alkyl group having 3 to 6 carbon atoms or that substituted by a cyano group is suitable.

X is a mono- or di-valent anion.

The mono-valent anion includes an organic acid anion and an inorganic anion. Examples of the mono-valent organic acid anion are an carboxylic acid ion such as an acetic acid ion, a lactic acid ion, a trifluoroacetic acid ion, a propionic acid ion, a benzoic acid ion, an oxalic acid ion, a succinic acid ion and a stearic acid ion, an organic sulfonic acid ion such as a methanesulfonic acid ion, a toluenesulfonic acid ion, a naphthalenesulfonic acid ion, a chlorobenzenesulfonic acid ion, a nitrobenzenesulfonic acid, a dodecylbenzenesulfonic acid ion, a benzenesulfonic acid ion, an ethane sulfonic acid ion and trifluoromethane sulfonic acid, and an organic boric acid ion such as a tetraphenylboric acid ion and a butyltriphenylboric acid ion, and a halogenoalkylsulfonic acid ion and alkylarylsulfonic acid ion such as trifluoromethanesulfonic acid ion, the toluenesulfonic acid ion are preferable.

Examples of the inorganic mono-valent anion include a halogen ion such as a fluorine ion, a chlorine ion, a bromine ion and an iodine ion, a thiocyanic acid ion, a hexafluoroanitimonic acid ion, a perchloric acid ion, a periodic acid ion, a nitric acid ion, a tetrafluoroboric acid ion, hexafluorophosphoric acid ion, a molybdic acid ion, a tungstic acid ion, a titanic acid ion, a vanadic acid ion, a phosphoric acid ion and a boric acid ion, and the perchloric acid ion, periodic acid ion, tetrfluoroboric acid ion, hexafluorophosphoric acid ion and hexafluoroantimonic acid ion are preferable.

Examples of the di-valent anion represented by X include an ion of naphthalenedisulfonic acid derivative such as naphthalene-1,5-disulfonic acid, R acid, G acid, H acid, benzoyl H acid, p-chlorobenzoyl H acid, p-toluenesulfonyl H acid, methanyl γ acid, 6-sulfonaphthyl-γ acid, C acid, ε acid, p-toluenesulfonyl R acid, naphthaline-1,6-disulfonic acid, and an ion of di-valent organic acid such as carbonyl J acid, 4,4′-diamonostilbene-2,2′-disulfonic acid, di-J acid, naphthalic acid, naphthaline-2,3-dicarboxylic acid, diphenic acid, stilbene-4,4′-dicarboxylic acid, 6-sulfo-2-oxy-3-naphthoic acid, anthraquinone-1,8-disulfonic acid, 1,6-diaminoanthraquinone-2,7-disulfonic acid, 2-(4-sulfophenyl)-6-aminobenzotriazole-5-sulfnic acid, 6-(3-methyl-5-pyrazonyl)-naphthalene-1,3-disulfonic acid and 1-naphthol-6-(4-amino-3-sulfo)anilino-3-sulfonic acid. Among the foregoing anions, for example, the perchloric acid ion, iodine ion, tetrafluoroboric acid ion, hexafluorophosphoric acid ion, hexafluoroantimonic acid ion, trifluoromethanesuofonic acid ion and toluenesulfonic acid ion are preferred.

Concrete examples of the immonium compound are shown below: (I-1) N,N,N′,N′-tetrakis(4-di-n-butylaminophenyl)-1,4-benzoquinone-bis(immonium.hexafluoroanitmonate)
(I-2) N,N,N′,N′-tetrakis(4-di-n-butylaminophenyl)-1,4-benzoquinone-bis(immonium.perchlorate)
(I-3) N,N,N′,N′-tetrakis(4-di-aminophenyl)-1,4-benzoquinone-bis(immonium.hexafluoroantimonate)
(I-4) N,N,N′,N′-tetrakis(4-di-n-propylaminophenyl)-1,4-benzoquinone-bis(immonium.hexafluoroantimonate)
(I-5) N,N,N′,N′-tetrakis(4-di-hexylaminophenyl)-1,4-benzoquinone-bis(immonium.hexafluoroantimonate)
(I-6) N,N,N′,N′-tetrakis(4-di-iso-propylaminophenyl)-1,4-benzoquinone-bis(immonium.hexafluoroantimonate)
(I-7) N,N,N′,N′-tetrakis(4-di-n-pentylaminophenyl)-1,4-benzoquinone-bis(immonium.hexafluoroantimonate) and
(I-8) N,N,N′,N′-tetrakis(4-di-methylaminophenyl)-1,4-benzoquinone-bis(immonium.hexafluoroantimonate).

The nickel dithiol complex compound can be represented by the following Formula 2.

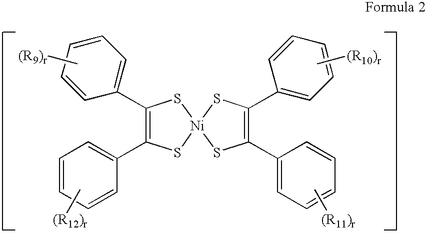

In the above formula, R₉, R₁₀, R₁₁ and R₁₂ are each independently a hydrogen atom, a halogen atom, an alkyl group, a cycloalkyl group, an aryl group, a hydroxyl group, a trifluoromethyl group, an alkylthio group, an arylthio group, a nitro group, a cyano group, an alkoxyl group, an aryloxy group or an alkylamino group. Each of the aromatic groups may have plural substituents; they may be different from each other.

Examples of the halogen atom, alkyl group, cycloalkyl group, aryl group, alkylthio group, arylthio group, aryloxy group and alkylamino group represented by R₉, R₁₀, R₁₁ and R₁₂ are as follows. Examples of the halogen atom are a fluorine atom, a chlorine atom, a bromine atom and an iodine atom, those of the alkyl group are a methyl group, an ethyl group, a propyl group, a butyl group, a pentyl group, and a hexyl group, those of the cycloalkyl group are a cyclopentyl group and a cyclohexyl group, those of the aryl group are a phenyl group and a p-nitrophenyl group, those of the alkylthio group are a methylthio group, an ethylthio group and a butylthio group, those of arylthio group are a phenylthio group and a tolylthio group, those of the alkoxy group are a methoxy group, an ethoxy group, an n-propoxy group, an iso-propoxy group, an n-butoxy group, an iso-butoxy group, an n-pentyloxy group and an iso-pentyloxy group, those of the aryloxy group are a phenoxy group, a 2-methylphenoxy group, a 3-methylphenoxy group, a 4-methylphenoxy group and a naphthoquinone group, and those of the alkylamino group are a methylamino group, an ethylamino group, an n-propylamino group, an iso-propylamino group, a butylamino group, a pentylamino group, a hexylamino group, a heptylamino group, an octylamino group, a nonylamino group, a benzylamino group, a dimethylamino group, a diethylamino group, a di-n-propylamino group, a di-iso-propylamino group, a di-n-butylamino group, a di-iso-butylamino group, a di-n-pentylamino group, a di-iso-pentylamino group, a di-n-hexylamino group, a di-n-heptylamino group, a di-n-octylamino group, a di-(20ethylhexyl)amino group, a dibenzylamino group, an arylamino group, a diphenyl amino group and a di-tolylamino group. In the formula, r is an integer of from 1 to 5.

Preferable concrete examples are listed below.

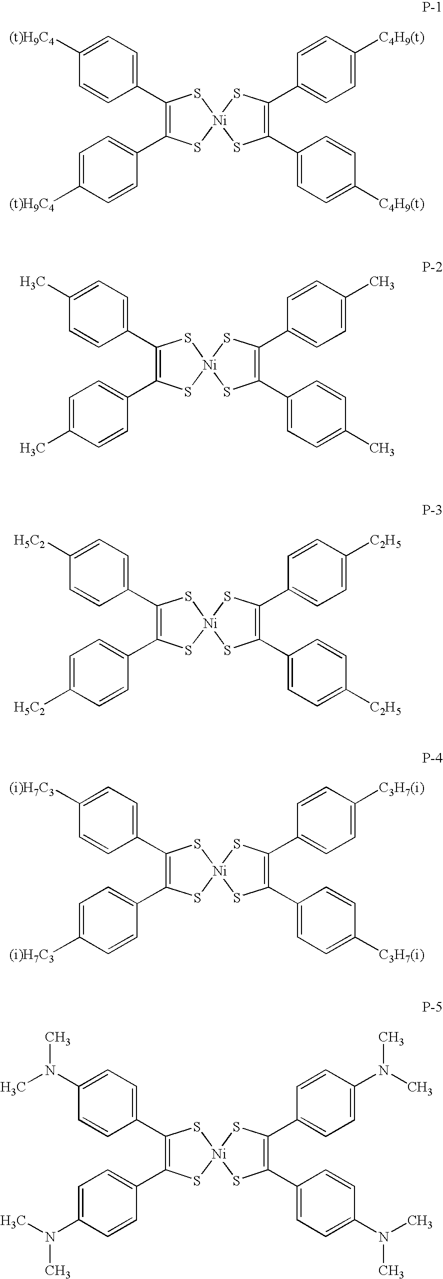

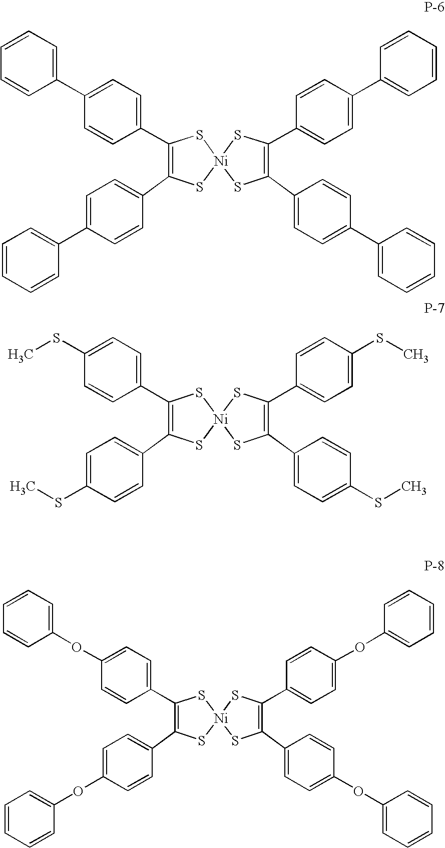

The phthalocyanine compounds preferably used in the present invention can be represented by the following Formula 3.

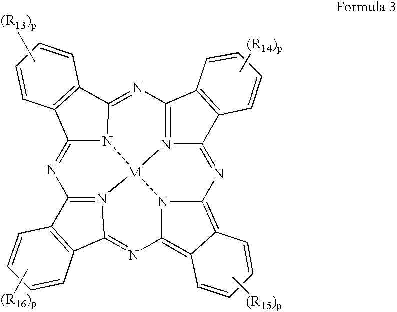

In the above formula, R₁₃ through R₁₆ are each independently a hydrogen atom, a halogen atom, a substituted or unsubstituted alkyl group, a substituted or unsubstituted alkoxy group, a substituted or unsubstituted aryl group, a substituted or unsubstituted aryloxy group, a substituted or unsubstituted alkylthio group or a substituted or unsubstituted arylthio group. Each of the aromatic rings may have plural substituents; they may be different from each other. M is a di-valent metal atom, tri- or tetra-valent substituted metal atom or an oxymetal.

Examples of the a halogen atom, substituted and unsubstituted alkyl group, substituted or unsubstituted alkoxy group, substituted or unsubstituted aryl group, substituted or unsubstituted aryloxy group, substituted or unsubstituted alkylthio group and substituted or unsubstituted arylthio group each represented by R₁₃ to R₁₆ are described below. Examples of the halogen atom are a fluorine atom, a chlorine atom, a bromine atom and an iodine atom, those of the substituted or unsubstituted alkyl group are a straight- or branched-chain alkyl group having 1 to 20 carbon atoms such as a methyl group, an ethyl group, an-n-propyl group, an isopropyl group, an n-butyl group, an iso-butyl group, a sec-butyl group, a t-butyl group, an n-pentyl group, an iso-pentyl group, a neo-pentyl group, a 1,2-dimethylpropyl group, an n-hexyl group, a cyclohexyl group, a 1,3-dimethyl-butyl group, a 1-iso-propylpropyl group, a 1,2-dimethylbutyl group, an n-heptyl group, a 1,4-dimethylpentyl group, a 2-methyl-1-iso-propylpropyl group, a 1-ethyl-3-methylbutyl group, an n-octyl group, a 2-ethylhexyl group, a 3-methyl-1-iso-propylbutyl group, a 2-methyl-1-iso-propyl group, a 1-t-butyl-2-methylpropyl group and an n-nonyl group, an alkoxyalkyl group such as a methoxymethyl group, a methoxyethyl group, an ethoxyethyl group, a propoxyethyl group, a butoxyethyl group, a γ-methoxypropyl group, a γ-ethoxypropyl group, a methoxyethoxyethyl group, an ethoxyethoxyethyl group, a dimethoxymethyl group, diethoxymethyl group, dimethoxyethyl group and a diethoxyethyl group, an alkoxyalkoxyalkyl group, an alkoxyalkoxyalkoxyalkyl group, a hogenoalkyl group such as a chloromethyl group, a 2,2,2-trichloroethyl group and a 1,1,1,3,3,3-hexafluoromethyl-2-propyl group, an alkylaminoalkyl group, a dialkylaminoalkyl group, an alkoxycarbonylalkyl group, an alkylaminocarbonylamino group and an alkoxyxulfonylalkyl group; those of the substituted or unsubstituted alkoxy group are a straight- or branched-chain alkoxy group having 1 to 20 carbon atoms such as a methoxy group, an ethoxy group, an nopropyloxy group, an iso-propyloxy group, an n-butyloxy group, an iso-butyloxy group, a sec-butyloxy group, a t-butyloxy group, an n-pentyloxy group, an iso-pentyloxy group, a neo-pentyloxy group, a 1,2-dimethyl-propyloxy group, an n-hexyloxy group, a cyclohexyloxy group, a 1,3-dimethylbutyloxy group, a 1-iso-propylpropyloxy group, a 1,2-dimethylbutyloxy group, an n-heptyloxy group, a 1,4-dimethylpentyloxy group, a 2-methyl-1-iso-propylpropyloxy group, a 1-ethyl-3-methylbutyloxy group, an n-octyloxy group, a 2-ethylhexyloxy group, a 3-methyl-1-iso-propyloxy group, a 2-methyl-iso-propyloxy group, a 1-t-butyl-2-methylpropyloxy group and an n-nonyloxy group, an alkoxyalkyl group such as a methoxymethoxy group, a methoxyethoxy group, an ethoxyethoxyethoxy group, a propoxyethoxy group, a butyoxyethoxy group, a γ-methoxypropyloxy group, a γ-ethoxypropyloxy group, a methoxyethoxyethoxy group, an ethoxyethoxyethoxy group, a dimethoxymethoxy group, a diethoxymethoxy group, a dimethoxyethoxy group and an ethoxyethoxy group, an alkoxyalkoxyalkoxy group such as a methoxyethoxyethoxy group, an ethoxyethoxyethoxy group and butyloxyethoxethoxy group, an alkoxyalkoxyalkoxyalkoxy group, a halogenoalkoxy group such as a chloromethoxy group, a 2,2,2-trichloroethoxy group, a trifluoromethoxy group, a 2,2,2-trichloroethoxy group and 1,1,1,3,3,3-hexafluoro-2-propyloxy group, an alkylaminoalkoxy group and an dialkylaminoalkoxy group such as a dimethylaminoethoxy group and a diethylaminoethoxy group; and those of the substituted or unsubstituted aryl group are a phenyl group, a halogenophenyl group such as a chlorophenyl group, a dichlorophenyl group, a bromophenyl group, a flulorphenyl group and an iodophenyl group, a tolyl group, a xylyl group, a mesityl group, an ethylphenyl group, a methoxyphenyl group, an ethoxyphenyl and a pyridyl group. Examples of the substituted or unsubstituted aryloxy group are a phenoxy group, a naphthoxy group and an alkylphenoxy group; those of the substituted or unsubstituted alkylthio group are a straight- or branched-chain alkylthio group having 1 to 20 carbon atoms such as a methylthio group, an ethylthio group, an n-propylthio group, an iso-propylthio group, an n-butylthio group, an iso-butylthio group, a sec-butylthio group, a t-butylthio group, an n-pentylthio group, an iso-pentylthio group, a neo-penthylthio group, a 1,2-dimethylpropylthio group, an hexylthio group, a cyclohexylthio group, a 1,3-dimethyl-butylthio group, a 1-isopropylpropylthio group, a 1,2-dimethylbutylthio group, an n-heptylthio group, a 1,4-dimethylpentylthio group, a 2-methyl-1-iso-propylpropylthio group, a 1-ethyl-3-methylbutylthio group, an n-octylthio group, a 2-ethylhexylthio group, a 3-methyl-1-iso-propylbutylthio group, a 2-methyl-1-iso-propylthio group, a 1-t-butyl-2-methylpropylthio group and an n-nonylthio group, an alkoxyalkylthio group such as a methoxymethylthio group, a methoxyethylthio group, an ethoxyethylthio group, propoxyethylthio group, a butoxyethylthio group, a γ-methoxypropylthio group, a γ-ethoxypropylthio group, a methoxyethoxyethylthio group, an ethoxyethoxyethylthio group, a domethoxymethylthio group, a diethoxymethylthio group, a dimethoxyethylthio group and a diethoxyethylthio group, an alkoxyalkoxyalkylthio group, alkoxyalkoxyalkoxyalkylthio group, a halogenoalkylthio group such as a chloromethylthio group, a 2,2,2-trichloroethylthio group, a trifluoromethylthio group, a 2,2,2-trichloroethylthio group, and 1,1,1,3,3,3-hexafluoro-2-propylthio group, and an alkylaminoalkylthio group and a dialkylaminoalkylthio group such as a dimethylaminoethylthio group and an diethylaminoethylthio group. Examples of the substituted or unsubstituted arylthio group are a phenylthio group, a naphthylthio group and an alkylphenylthio group.

Ones represented by M include the followings. Examples of the di-valent metal include Cu(II), Zn(II), Co(II), Ni(II), Ru(II), Pd(II), Pt(II), Mn(II), Mg(II), Yi(II), Be(II), Ca(II), Ba(II), Hg(II), Pb(II) and Sn(II); those of the tri-valent metal having one substituent include Al—Cl, Al—Br, Al—F, Al—I, Ga—Cl, Ga—F, Ga—I, Ga—Br, In—Cl, In—Br, In—I, In—F, Tl—Cl, Tl—Br, Tl—I, Tl—F, Al—C₆H₅, Al—C₆H₄(CH₃), In—C₆H₅, In—C₆H₄(CH₃), Mn(OH), Mn(OC₆H₅), Mn[OSi (CH₃)₃], Fe—Cl and Ru—Cl; and those of the tetra-valent metal having two substituents include CrCl₂, SiCl₂, SiBr₂, SiF₂, ZrCl₂, GeCl₂, GeBr₂, GeI₂, GeF₂, SnCl₂, SnBr₂, SnF₂, TiCl₂, TiBr₂, TiF₂, Si(OH)₂, Ge(OH)₂, Zr(OH)₂, Mn(OH)₂, Sn(OH)₂, TiR₂, CrR₂, SiR₂, SnR₂, GeR₂, Si(OR′)₂, Sn(OR′)₂, Ge(OR′)₂, Ti(OR′)₂, Cr(OR′)₂, Sn(SR″)₂ and Ge(SR″)₂, in which R is an alkyl group, a phenyl group, a naphthyl group or a group derived from them, R′ is an alkyl group, a phenyl group, a trialkylsilyl group, a dialkylalkoxysilyl group or a group derived from them and R″ is an alkyl group, a phenyl group, a naphthyl group or a group derived from them). Examples of the oxymetal include VO, MnO and TiO. p is an integer of from 1 to 4. When the substituents are adjacent with each other, they may for a 5- or 6-member ring. For synthesizing the compounds, JP-A No. 2005-145896 can be referred.

For synthesizing the phthalocyanine compounds, JP-A No. 2005-145896 can be referred. Preferable phthalocyanine compounds are listed below.

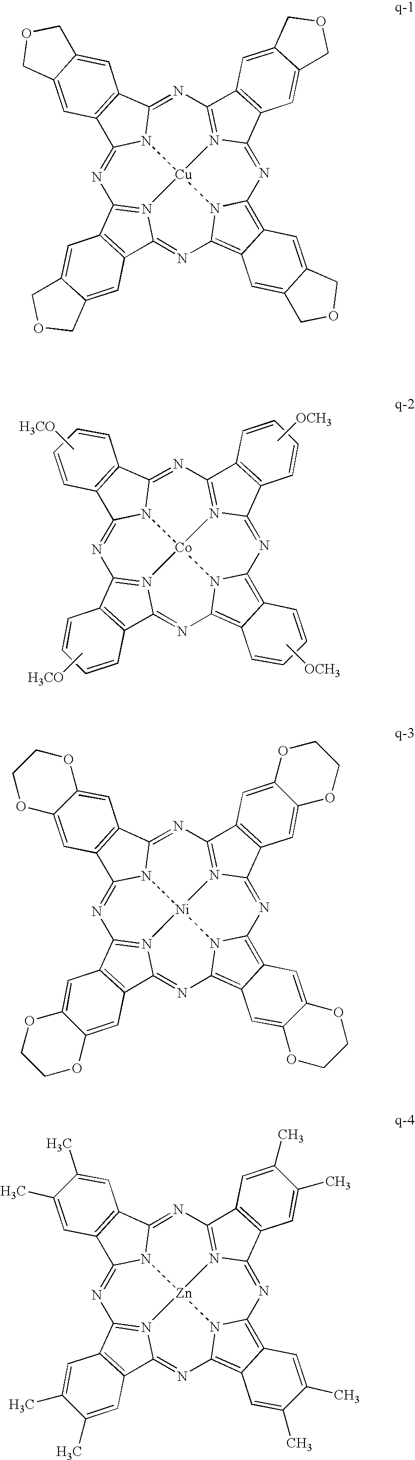

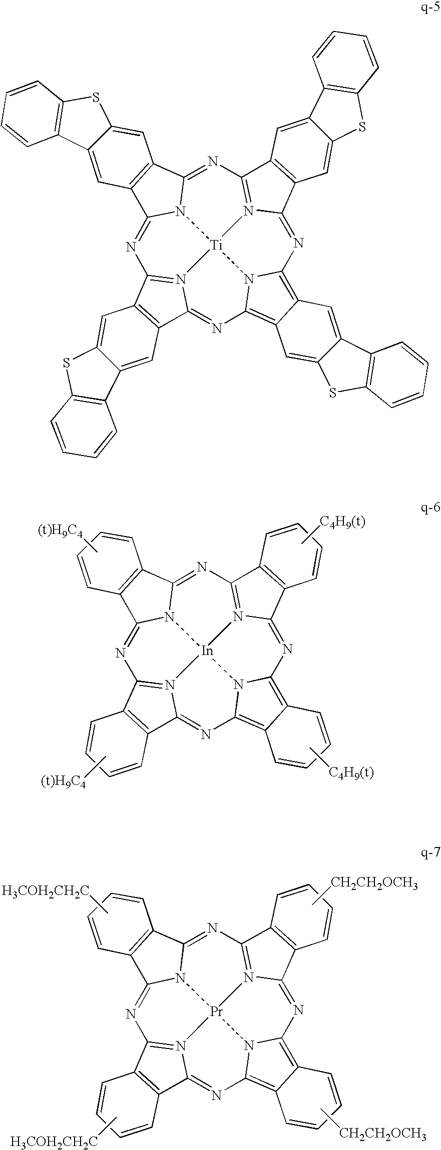

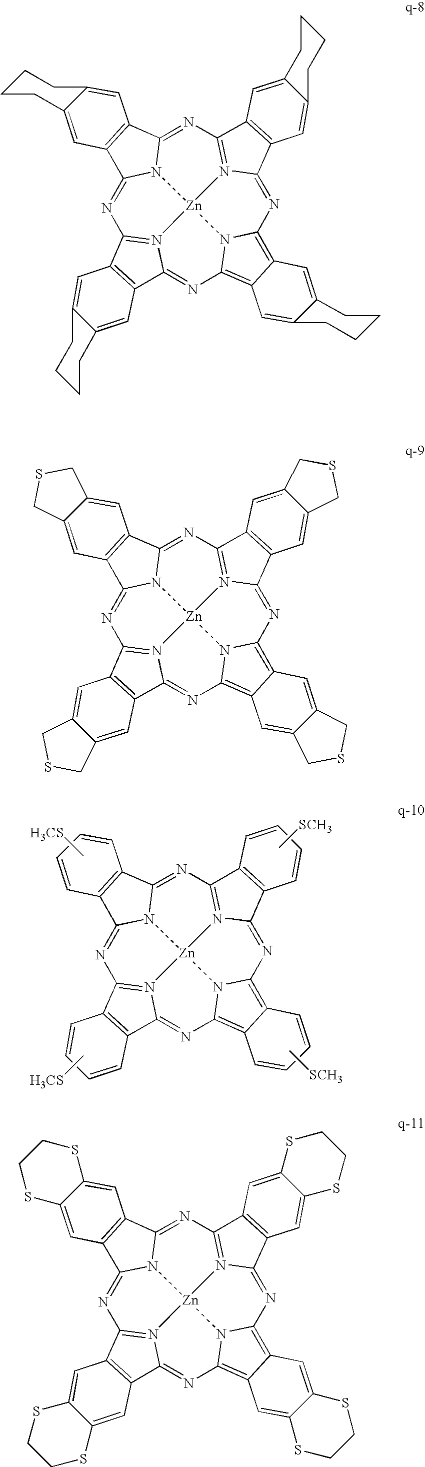

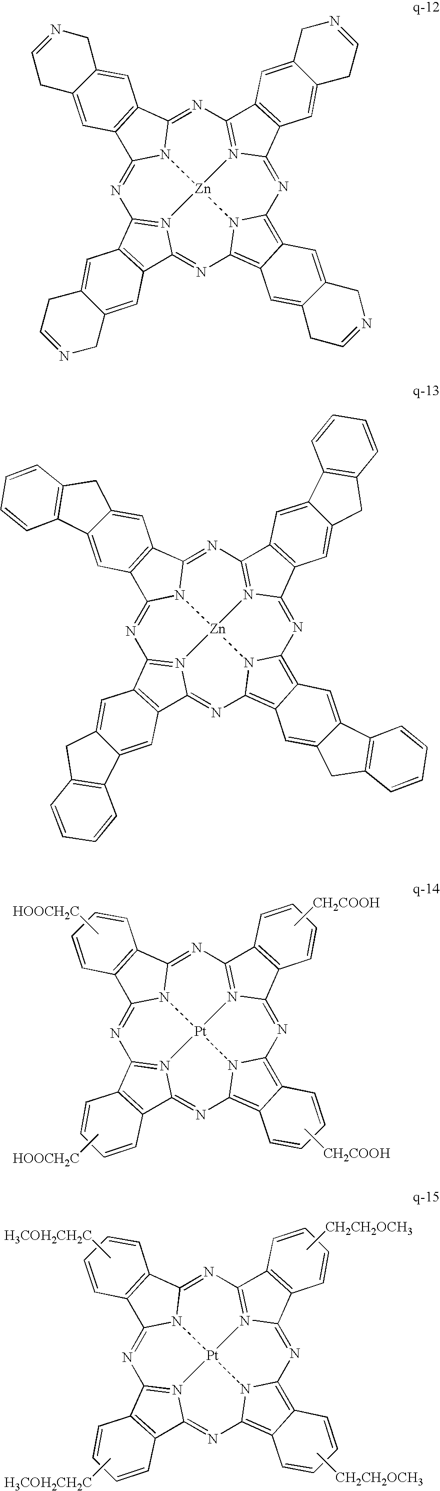

The squalium type compound can be represented by the following Formula 4.

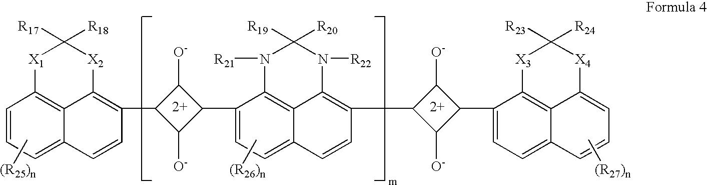

In the above formula, R₁₇ through R₂₇ are each independently an alkyl group, a cycloalkyl group, an aryl group, an aralkyl group or a heterocyclic group; they may have a substituent, and m and n are each an integer of from 1 to 6.

The alkyl group represented by each of R₁₇ through R₂₇ is an alkyl group having 1 to 20, more preferably from 1 to 12, carbon atoms such as a methyl group, an ethyl group, a propyl group, a butyl group, a hexyl group and an undecyl group, which may substituted by a halogen atom such as F, Cl and Br, an alkoxycarbonyl group such as a methoxycarbonyl group and an ethoxycarbonyl group, a hydroxyl group, an alkoxy group such as a methoxy group, an ethoxy group, a phenoxy group and an iso-butoxy group, an acyloxy group such as an acetyloxy group, a butylyloxy group, a hexylyloxy group and a benzoyloxy group, a sulfo group or its salt, or a carboxyl group or a its salt.

The examples of the cycloalkyl group represented by R₁₇ through R₂₇ include a cyclopentyl group and a cyclohexyl group.

The aryl group represented by each of R₁₇ through R₂₇ is preferably one having 6 to 12 carbon atoms and a phenyl group and a naphthyl group are exemplified. The aryl group may have a substituent. Examples of the substituent include an alkyl group having 1 to 8 carbon atoms such as a methyl group, an ethyl group and a butyl group, an alkoxy group having 1 to 6 carbon atoms such as a methoxy group and an ethoxy group, an aryloxy group such as a phenoxy group and a p-chlorophenoxy group, a halogen atom such as F, Cl and Br, an alkoxycarbonyl group such as a methoxycarbonyl group and an ethoxycarbonyl group, an amino group such as a methylamino group, an acetylamino group and a methanesulfonamide group, cyano group, a nitro group, a carboxyl group and its salt and a sulfo group and its salt.

The aralkyl group represented by each of R₁₇ to R₂₇ is preferably an aralkyl group having 7 to 12 carbon atoms such as a benzyl group and a phenylethyl group, which may have a substituent such as a methyl group, a methoxy group and a halogen atom.

Examples of the heterocyclic group represented by each of R₁₇ to R₂₇ include a thienyl group, a furyl group, a pyrrolyl group, a pyrazolyl group, a pyridyl group and an indolyl group. The substituents adjacent with each other may be linked to form a cyclopentene ring or a cyclohexane ring. The compound represented by Formula 4 may be a mixture. Regarding the compound, D. J. Gravesteijnetal, “Optical Storage Media”, SPIE-420, p. 327, 1983 can be referred.

Squalium compounds represented by Formula 5 are also preferably usable. 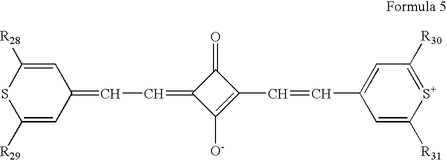
wherein R₂₈-R₃₁ each are the same as the group defined by above R₁₇-R₂₇.

Examples of preferable squalium compounds are listed below.

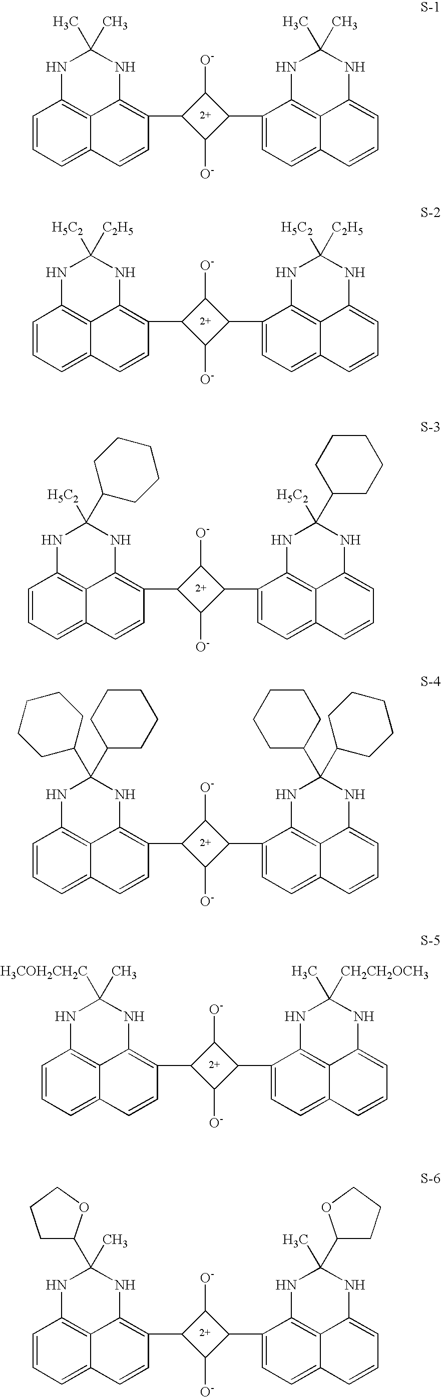

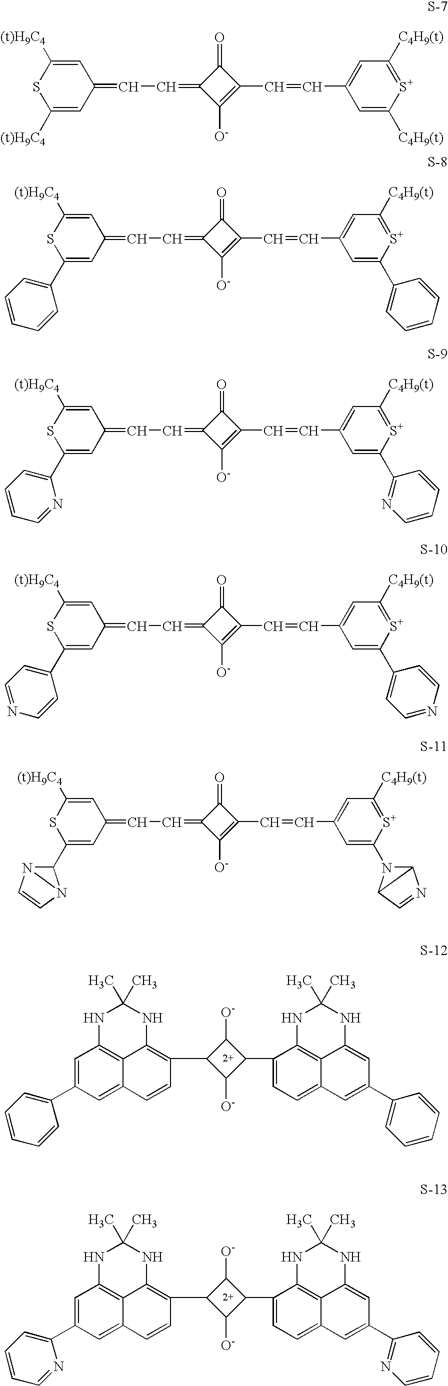

Examples of the near-infrared ray absorbing dye to be used in the present invention available on the market include the immonium compound of IRG-022 and IRG-040 each commercial name of Nihon Kayaku Co., Ltd., and the nickel dithiol complex compound of SIR-128, SIR-130, SIR-130, SIR-132, SIR-159, SIR-152 and SIR-162 each commercial name of Mitsui kagaku Co., Ltd., and the phthalocyanine compound of IR-10 and IR-12, each commercial name of Nihon Shokubai Co., Ltd. In the present invention, examples of a preferable near-infrared ray absorbing dye include a diimmonium compound, a nickel dithiol compound, a phthalocyanine compound and a squalium compound, and more preferable is a squalium compound. A compound represented by Formula 5 is specifically preferable.

The near-infrared ray absorbing dye is preferably used in a form of a solution in an organic solvent, for example, an alcohol type solvent such as methanol, ethanol and propanol, a ketone type solvent such as acetone, methyl ethyl ketone and methyl butyl ketone, dimethylsulfoxide, dimethylformamide, dimethyl ether and toluene, or in a form of particle of from 0.01 to 10 μm prepared by the later-mentioned pine particle forming machine. The adding amount is preferably decided so that the optical density at the maximum absorbing wavelength becomes 0.05 to 3.0. The amount of applied near-infrared ray absorbing dye is preferably 1×10⁻⁶−1×10⁻¹ mole/m² and more preferably 1×10⁻⁵−1×10⁻² mole/m².

When the near-infrared ray absorbing dye is added to the tone compensation layer, the dye may be added singly or in combination of two or more kinds. It is preferable to use a UV absorbent for avoiding the deterioration of the near-infrared ray absorbing dye caused by UV rays.

As the UV absorbent, know UV absorbent such as a salicylic acid type compound, a benzophenone type compound, a benzotriazole type compound, an S-triazine type compound and cyclic imino ester type compound can be preferably used. Among them, the benzophenone type compound, benzotriazole type compound and cyclic imino compound are preferable. The cyclic imino ester compound is particularly preferable for using together with polyester.

Preferable examples of the UV absorbent are as follows:
(U-1) 2-(2-hydroxy-3,5-di-α-cumyl)-2H-benzotriazole
(U-2) 5-chloro-2-(2-hydroxy-3-t-butyl-5-methylphenyl)-2H-benzotriazole
(U-3) 5-chloro-2-(2-hydroxy-3,5-di-t-butylphenyl)-2H-benzotriazole
(U-4) 5-chloro-2-(2-hydroxy-3,5-di-α-cumylphenyl-2H-benzotriazole
(U-5) 5-chloro-2-(2-hydroxy-3-α-cumyl-5-t-octylpheny-2H-benztriazole
(U-6) 2-(3-t-butyl-2-hydroxy-5-(2-iso-octyloxy-carbonyl-ethylphenyl)-5-chloro-2H-benzotriazole
(U-7) 5-trifluoromethyl-2-(2-hydroxy-3-α-cumyl-5-t-octylphenyl)-2H-benzotriazole
(U-8) 5-trifluoromethyl-2-(2-hydroxy-5-t-octylphenyl)-2H-benzotriazole
(U-9) 5-trifluoromethyl-2-(2-hydroxy-3,5-di-t-octylphenyl)-2H-benzotriazole
(U-10) 5-trifluoromethyl-2-(2-hydroxy-3-α-cumyl-5-t-butylphenyl)-2H-benzotriazole
(U-11) 2,4-bis(4-biphenylyl)-6-(2-hydroxy-4-octyloxycarbonylethylideneoxyphenyl)-s-triazine
(U-12) 2,4-bis(2,4-dimethylphenyl)-6-[2-hydroxy-4-(3-nonyloxy*-2-hydroxypropyloxy-5)-α-cumylphenyl-s-triazine; * is a mixture of octyloxy group, nonyloxy group and decyloxy group
(U-13) 2,4,6-tris(2-hydroxy-4-iso-octyloxycarbonyl-isopropylideneoxyphenyl)-s-triazine
(U-14) Hydroxyphenyl-2H-benzotriazole
(U-15) 2-(2-hydroxy-5-methylphenyl)-2H-benzotriazole
(U-16) 2-(3,5-di-t-butyl-2-hydroxyphenyl)-2H-benzotriazole

An upper layer of the near-infrared ray absorbing layer (the uppermost layer or a protective layer) or a intermediate layer provided between the near-infrared ray absorbing layer and the upper layer is described below. The binder of the layer is not specifically limited. As the polymer for the binder, for example, gelatin, poly(vinyl alcohol), casein, agar, gum arabic, hydroxyethyl cellulose, cellulose acetate, cellulose acetate butylate, poly(vinyl chloride), poly(methacrylic acid), poly(vinylidene chloride) and poly(vinyl acetate) are usable.

Gelatin is most preferable among the hydrophilic binders. Any type of gelatin such as lime processed gelatin and acid processed gelatin is usable and a gelatin derivative is also usable. Latex of homo- or co-polymer of styrene, methyl methacrylate, acrylic acid, butyl acrylate or ethyl acrylate may be added to the hydrophilic polymer of the binder. The dispersibility in water of the latex can be improved by copolymerizing in an amount of from 1 to 20 mole % of a monomer having a nonionic group such as an ester of polyethylene glycol and acrylic acid, a monomer having an anionic group such as a monomer having a carboxylic group such as itaconic acid and acrylic acid or having a sulfonic acid group such as styrenesulfonic acid and N-dimethylsulfopropaneacrylamide.

The thickness of the layer adjacent to the near-infrared ray absorbing layer of the present invention is 0.1 to 10 μm, and preferably from 0.5 to 5 μm, per one layer. The adjacent layer is preferably formed by coating and drying an aqueous coating liquid. A matting agent can be used in the adjacent layer and the matting agent is preferably a particle of polystyrene, poly(methyl methacrylate or silica is preferable. The spherical particle is preferable though the particle shape is not specifically limited. The particle diameter of the matting agent is preferably from 0.2 to 20 μm, and more preferably from 0.5 to 10 μm. The adding amount of the matting agent is preferably from 10 to 200 mg/m² and more preferably from 20 to 100 mg/m² though the amount cannot be unconditionally decided since which is varied depending on the layer structure and the using purpose of the near-infrared ray absorbing material of the present invention.

The slipping agent to be used in the uppermost layer may be compounds known in the industrial field, for example, a silicone compound such as a dimethylsiloxane polymer, a phthalate of higher alcohol such as dilauryl phthalate, and paraffin. Preferable slipping agent are, for example, the higher fatty acids amides described in U.S. Pat. No. 4,275,146, the higher fatty acids and their metal salts described in U.S. Pat. No. 3,933,516, a higher alcohol and its derivative, a polyethylene wax, a paraffin wax, a microcrystalline wax and a polyoxyethylene alkylphenyl ether. Moreover, natural fat, wax, oil such as beeswax may be used additionally to the above agents. Moreover, silicone compounds available on the market or prepared by synthesizing are preferable for the slipping agent to be used together with the above-mentioned materials. Among the silicone compounds, polyorganosiloxane compounds are preferred. The slipping agents are preferably added in a form of dispersion in the aqueous coating liquid.

The slipping agent to be used in the present invention is added to the uppermost layer in a form of an aqueous dispersion. The aqueous dispersion may contain a suitably selected organic solvent. Examples of the usable organic solvent include a ketone such as acetone, methyl ethyl ketone, methyl isobutyl ketone and cyclohexanone, an alcohol such as a lower alcohol having 1 to 8, for example, methyl alcohol, ethyl alcohol, iso-propyl alcohol, butyl alcohol, hexyl alcohol and octyl alcohol, a glycol derivative such as cellosolve, ethylene glycol diethyl ether and propylene glycol mono-methyl ether, a lower fatty acid ether having 1 to 5 carbon atoms such as ethyl acetate, butyl acetate and ethyl propionate, a haloalkane such as methylene dichloride, ethylene dichloride, trichlene, trichloromethane, trichloroethane and carbon tetrachloride, a hydrocarbon such as octane, solvent naphtha, turpentine oil, thinner, petroleum benzin, benzene, toluene and xylene, a phenol such as phenol and resorcin, ether such as tetrahydrofuran and dioxane, a phosphate such as trimethyl phosphate, triethyl phosphate and tributyl phosphate, an amide type DMF and another DNSO. The alcohols, ketones, glycol derivatives, lower fatty acid esters, haloalkanes and hydrocarbons are preferable. Particularly, in the solvent system in which the solvent is used with water in combination, the solvent is selected from the alcohols, ketones and glycol derivatives each capable of forming a uniform solvent system together with water, and the hydrocarbons, ketones, lower fatty acid ester and haloalkane are preferable for a solvent when water is not used.

The ratio of water and the organic solvent is from 100 to 50/0 to 50, and more preferably from 100 to 75/0 to 25, in volume percent. Thus the aqueous coating liquid can be obtained, which is superior in the stability of the slipping agent dispersion and the coating suitability, and the flatness, anti-dust adhesion ability and anti-damage ability of coated layer. The above organic solvent may be used singly or in a form of mixture of two or more kinds thereof. The fine dispersion can be obtained by known dispersing method such as dispersing by mechanical sharing force, ultrasonic dispersing or a precipitation formation of two solutions. The adding amount of the slipping agent is preferably 0.2 to 500 mg/m² and more preferably from 1 to 300 mg/m². The slipping agent may be used singly or in combination of two or more kinds thereof. Damages caused by conveying the film on the stainless steel rollers is inhibited by the slipping agent. Therefore, the dynamic frictional coefficient of the film is preferably from 0.1 to 0.3. A dynamic frictional coefficient of less than 0.2 is not preferable since high accurate transportation can be difficultly performed. It is necessary to remove coarse particles from the coating liquid by filtration before the coating. The filtration is carried out by a filter, and the kind and the structure of the filter is not specifically limited and any filter can be used as long as it can remove a foreign material capable of not passing through a pore of from 2 to 10 μm. The system for removing the coarse particle by the filter is also not specifically limited as long as a large problem is not caused in the filtration.

As the material of the filter, for example, paper, cloth, cellulose acetate polymer, polysulfone, polyethersulfone, polyacrylnitrile, polyether, fluoropolymer such as poly(vinylidene fluoride), polyamide, polyimide, polyethylene, polypropylene, stainless steel and ceramic are usable. The shape of the filter is not limited and a flat membrane, a membrane cartridge and a hollow fiber membrane are applicable. In the present invention, a flat membrane of clothe or paper is preferable and a cartridge filter and ceramic filter are more preferable. A housing for attaching the filter is preferably used for the near-infrared ray absorbing layer coating liquid preparation by such the membrane of disk type or the filter cartridge.

As the filter, Pall Epocel (various sizes), Profile Filter (with pore size of 2, 3, 5 or 10 μm) each sold by Pall Co., Ltd., and CN03 (3 μm) and CN06 (6 μm) each sold by Millipore Co., Ltd., are usable. In these filters, the filtering area is increased by pleating the flat membrane so that the filter is made compact and suitable for space saving.

The method for filtering is not specifically limited as long as the coarse particles can be removed without blocking of the coating liquid to be filtered. Generally, the filter is effectively used by providing in the housing; in such the sate the space for installing the apparatus can be saved. The housing made from stainless steel or polypropylene available on the market is preferable. The size and shape of the housing are not specifically limited and ones of circular type and square type may be used, and a filtration system having one filter and that having two or more filters are also applicable. Moreover, the filtering area can be considerably increased by connecting two or more filters. The flat type filter can be also usable in the present invention. The filter is used in a common filtering method, namely the filtering apparatus is set upon a receiving vessel and a liquid storing means are securely fixed on the filtering apparatus; the fitting up portion of the filtering apparatus is tightly fastened so as to prevent the leak of filtrate. On this occasion, a packing may be arranged at the fitting portion of the filtering apparatus for preventing the leaking of filtrate.

The filtration of the coating liquid of the present invention is preferably performed by passing the liquid while applying pressure or reduced pressure for removing the coarse particles though the pressure for conveying the liquid is not specifically limited. A method is frequently applied in which the pressure is applied by conveying the liquid by a pump, and a method applying natural pressure by placing the liquid at a position higher than that of the filter is also preferred. A method for applying pressure by gas to the coating liquid is also preferred, in such the case the tank containing the coating liquid is practically made to a closed system. The pressure which is applied by the pump for conveying the liquid, natural pressure or by the gas is not limited as long as the pressure filter does not cause deterioration of the filter by damaging or blocking. For example, the pressure to be applied to the filter is preferably from 0.005 kg/cm² to 50 kg/cm², more preferably from 0.01 kg/cm² to 10 kg/cm², and further preferably from 0.1 kg/cm² to 5 kg/cm². When the filtration is carried out by reducing pressure in the filtrate receiving means, the vacuum degree is preferably from 100 kPa to 1 kPa, more preferably from 93 kPa to 13 kPa, and further preferably from 93 kPa to 52 kPa.

In the preferable embodiment of the present invention, the filtration of the coating liquid before the coating is necessary for inhibiting a comet repellency and a defect caused by foreign maters. The period from the filtration to the coating is not specifically limited. The filtration of the coating liquid may be performed before coating for satisfactory long time when any coarse particles are not formed in the filtered coating liquid. It is preferable considering the product coefficient that the filtration is carried out within the range of from just before the coating to 12 months, more preferably from just before the coating to 6 months, further preferably just before the coating to 1 month, and particularly preferably within the range of from just before the coating to 15 days. The “just before coating” includes the case of the coating liquid is in the liquid conveying pipe connecting the tank stocking the coating liquid to the coating hopper. In such the case, the filtration is preferably carried out by an in-line filtration. The filtered coating liquid may be temporarily stocked in a stocking tank other than the final coating line.

In the present invention, at least one of the coating liquids is filtered even when plural layers are coated. It is preferable that the coating liquids for all layers are filtered. In the present invention, the filtration of the coating liquid is essential because the filtering process gives the largest influence on the product quality. Moreover, the layers other than the near-infrared ray absorbing layer such as the adjacent layer, a protective layer and another functional layer influence also on the surface state of the coated layer. It is very preferable that the coating liquid for forming the layer other than the near-infrared ray absorbing layer is preliminary filtered before the coating. Particularly, the filtration of the layer other than the near-infrared ray absorbing layer is preferable for preventing occurrence of defects such as unevenness of the image and pinholes when an additive material for forming an image is added into such the layer. Generally, the intermediate layer, protective layer and the functional layer relating to the present invention are each mainly comprised of the latex binder and contain another water-soluble compound and a dispersing material. Various kinds of additive such as the UV absorbent, a layer property improving agent, a surfactant and a pH controlling agent are usable without any limitation. Among them, the slipping agent, the matting agent, a surfactant for coating, an antistatic agent, a layer property improving agent such as colloidal silica are added for improving the surface properties. The slipping property of the outermost layer of the layers containing the near-infrared ray absorbing layer is preferably 0.03 to 0.4, more preferably from 0.05 to 0.35, further preferably from 0.05 to 0.3, and particularly preferably from 0.05 to 0.2, in dynamic frictional coefficient. The dynamic frictional coefficient is measured by moving a stainless steel ball having a diameter of 5 mm on the outermost layer of the near-infrared ray absorbing material in a rate of 60 mm/second while applying a load of 100 g under conditions of 25° C. and 60% of RH.

For filtration of the coating liquid of the other functional layer, filters that same as those usable for the coating liquid of the near-infrared ray absorbing layer can be applied. Other than those, CN25 (25 μm) is also usable. The pore diameter of the filter is preferably from 2 to 30 μm, more preferably from 2 to 10 μm, and particularly preferably from 2 to 5 μm, and a filter having a pore size of from 2 to 3 μm is preferably used in some cases.

Large particle of the matting agent are generally added to the coating liquid for giving roughness to the surface. Therefore, the pore size of the filter should have certain largeness, for example, a pore size of from 2 to 30 μm is preferable and more preferably from 5 to 25 μm. When the matting agent-containing layer coating liquid is previously prepared, it is preferable that a liquid containing matting agent and a liquid containing other materials are each separately filtered by a filter having large pore size and that having fine pore sized, respectively, and then mixed them for coating. In the present invention, it is essential to filter the coating liquid.

The glass transition point of the latex contained in the outermost protective layer of the near-infrared ray absorbing layer of the present invention is within the range of from 20° C. to less than 70° C. and the content of the latex is from 65 to 100% by weight of the whole amount of the binder in the outermost layer. The near-infrared ray absorbing layer improved in the water resistivity and superior in the anti-blocking property can be obtained by forming the outermost protective layer satisfying the above conditions.

The water resistivity of the outermost protective layer can be evaluated by measuring the increase in the thickness or swelling of the near-infrared ray absorbing layer when a drop of water is dropped on the surface the near-infrared ray absorbing material and leaving for 1 minute at 25° C. The swelling is preferably not more than 2 μm, more preferably not more than 1.5 μm, and further preferably not more than 1 μm.

A water-soluble polymer such as gelatin, poly(vinyl alcohol) (PVA), polyacrylamide, water-soluble (meth)aryl polymer and water-soluble sugar polymer can be used in the outermost protective layer of the near-infrared absorbing material of the present invention. PVA and the water-soluble polysaccharide are preferably used. As the PVA, a usual PVA available on the market having a saponified degree of from 80 to 99% and a polymerization degree of from 200 to 5,000, various kinds of modified poly(vinyl alcohol) such as an alkyl-modified PVA, an anion-modified PVA, a silane-modified PVA, a thiol-modified PVA and a hydrophobic group-modified PVA are usable. As the water-soluble polysaccharide, water-soluble starch, dextran, pectin, agar, mannan, carrageenan, pullulan, alginic acid, and water soluble cellulose derivatives such as methyl cellulose, hydroxyl cellulose, carboxymethyl cellulose and hydroxypropyl cellulose are usable. The content of the water-soluble polymer in the outermost protective layer of the near-infrared ray absorbing material is preferably from 6 to 30%, and more preferably from 10 to 30%, by weight of the whole amount of the binder in the outermost protective layer.

As the latex to be used together with the water-soluble polymer in the outermost protective layer of the near-infrared ray absorbing layer of the present invention, for example, a methyl methacrylate/ethyl acrylate/methacrylic acid copolymer latex, a methyl methacrylate/2-ethylhexyl acrylate/styrene/acrylic acid copolymer latex, a styrene/butadiene/acrylic acid copolymer latex, a styrene/butadiene/vinylbenzene/methacrylic acid copolymer, a methyl methacrylate/vinyl chloride/acrylic acid copolymer latex and a vinyl chloride/ethyl acrylate/acrylonitrile latex can be cited.

The glass transition point of the latex to be used in the outermost protective layer of the near-infrared ray absorbing material of the present invention is preferably not less than 20° C. and less than 170° C., and more preferably not less than 20° C. and less than 60° C. When the glass transition point of the latex is too low, adhesion tend to be caused during storage in piled state. When the glass transition point of the latex is too high, the water resistivity tend to be difficultly obtained.

The content of the latex in the outermost protective layer of the near-infrared ray absorbing material of the present invention is preferably from 65 to 100%, and more preferably from 70 to 90%, by weight. Though higher content of the polymer latex is preferable for raising the water-resistivity, excessively higher content tends to cause formation thin skin at the surface of the coated layer in the course of drying so as to cause defects such as reticulation, wrinkles and cracks and the viscosity of the coating liquid tens to be difficultly controlled. When the latex content is too low, the water-resistivity tends to be difficultly obtained.

In the outermost protective layer of the near-infrared ray absorbing material, the total amount of the water-soluble polymer and the polymer latex is preferably from 0.3 to 4.0 g/m², and more preferably from 0.3 to 2.0 g/m².

The protective layer may be constituted by two or more layers according to necessity. For example, the water-resistivity and the adhesiveness can be improved by constituting the protective layer by two layers and one of them provided at the nearer position to the near-infrared ray absorbing layer is formed by coating liquid containing the latex. Moreover, the compatibility of the infrared ray absorbing ability and the suitability of production can be made by lowering the pH of the coating liquid of the layer provided at the nearer position to the near-infrared ray absorbing layer and raising the pH of the surface side layer coating liquid to higher than 5. The near-infrared ray absorbing material can be designed so that the coating ability, producing suitability and the infrared ray absorbing ability can be made compatible by selecting the layer to which the additive relating to the infrared ray absorbing property, layer surface pH controlling agent, static electricity controlling agent, slipping agent and hardening agent to be added.

In the present invention, a matting agent can be added to the outermost protective layer for improving the anti-blocking property and the transportation suitability. The matting agent can be also added to a layer functioning as the outermost protective layer or a layer nearing the outer surface layer. Regarding the matting agent, JP-A No. 11-65021, paragraphs 0126 and 0127, can be referred. The using amount of the matting agent is preferably from 1 to 400 mg, and more preferably from 5 to 300 mg, per square meter of the near-infrared ray absorbing material. The matting degree of the outermost layer of the near-infrared ray absorbing layer is preferably from 30 to 2,000 seconds, and more preferably from 40 to 1,500 seconds, in Bekk smoothness though the matting degree can be further increased as long as the haze does not cause any problem. The matting degree in Bekk smoothness of the back surface is preferably from 10 to 1,200 second, more preferably from 20 to 800 seconds, and further preferably from 4 to 500 seconds. In other word, the Ra according to JIS-B0601 of the outermost surface is from 0.1 to 10 μm, preferably from 0.3 to 5 μm, and more preferably from 0.5 to 3 μm. The resistivity against finger marking and the peeling property on the occasion of transportation can be controlled by making the Ra to a value within the above range. When the Ra is too low or less than 0.1 μm, the finger mark is easily printed by the moist finger with sweat. When the Ra is too high or more than 10 μm, the ratio of the particle of the matting agent projected from the surface is raised which is easily fallen off from the surface by a little friction so that the image defects tends to be easily caused additionally to the problem of the haze.

The whole amount of the near-infrared ray absorbing layer is preferably from 0.2 to 30 g/m², and more preferably from 1.0 to 15 g/m². The whole amount of the binder of the protective layer is from 0.2 to 10.0 g/m², and more preferably from 0.5 to 6.0 g/m². The whole amount of the binder in the layer provided on the side opposite to the near-infrared ray absorbing layer is preferably from 0.01 to 10.0 g/m², and more preferably from 0.05 to 5.0 g/m².

The each of the above layers is constituted sometimes by two or more layers. When the near-infrared ray absorbing layer is constituted by two or more layers, the latex is preferably used in all of the layers. The protective layer is a layer provided on the near-infrared ray absorbing layer, which may be constituted by two or more layers, the latex is preferably used in at least one of them, particularly in the outermost protective layer. The backing layer is a layer provided on the subbing layer on the backside of the support, which is constituted by two or more layers in some cases, and the latex is preferably used in at least one of them, particularly in a under layer of the outermost layer.

In the present invention, each of the above layers can be formed by using a first latex having a functional group described in JP-A No. 2000-19678, paragraphs [0023] to [0041] and a second latex together with a crosslinking agent and/or the second latex having a functional group capable of reacting with the first latex. Concrete examples of the functional group include a carboxyl group, a hydroxyl group, an isocyanate group, an epoxy group, an N-methylol group, an oxazolone group, an amino group and a Vinylsulfon group, and those of the crosslinking agent include an epoxy compound, an isocyanate compound, a blocked isocyanate compound, a methylol compound, a hydroxyl compound, a carboxyl compound, an amino compound, an ethyleneimine compound, an aldehyde compound and a halogen compound. As concrete example of the crosslinking agent the followings can be cited: The isocyanate compound such as hexamethylene isocyanate, Duranate WB40-80D and WX-1741 each manufactured by Asahi Kasei Kogyo Co., Ltd., Bayhydur 3100 manufactured by Sumitomo Byer Urethane Co., Ltd., Takenate WD 725 manufactured by Takeda Yakuhin Kogyo Co., Ltd., Aquanate 100 and 200 manufactured by Nihon Polyurethane Co., Ltd., and the aqueous dispersion type polyisocyanate described in JP-A No. 9-160172; the amino compound such as Sumitex Resin M-3 manufactured by Sumitomo Kagaku Kogyo Co., Ltd.; the epoxy compound such as Denacol EX-614B manufactured by Nagase Kasei Kogyo Co., Ltd.; and the halogen compound such as sodium 2,4-dichloro-6-hydroxy-1,3,5-triazine.

Known crosslinking agents such as epoxy compounds, isocyanate compounds and melamine compounds are usable in the present invention. When the binder is gelatin, an aldehyde type crosslinking agent such as glyoxal and glutalaldehyde, a cyanuric acid type and a vinylsulfone type crosslinking agent can be used in combination. The adding amount of the crosslinking agent is preferably from 0.1 to 20%, and more preferably from 1 to 10%, by weight of the binder in usual. The addition of the crosslinking agent is necessary for increasing the layer strength and the adhesiveness between the layers. The hardness of the outermost surface is not more than 3H, preferably not more than 2H, by pencil hardness. The amount and using method of the crosslinking agent is preferably selected so to obtain such the hardness.

In the present invention, it is preferable that the layers are each formed by coating and drying aqueous coating liquids. Here, the “aqueous” means that water accounts for not less than 60% by weight of the solvent of the coating liquid. A water permissible organic solvent methanol, ethanol, isopropanol, methyl cellosolve, ethyl cellosolve, dimethylformamide, ethyl acetate, diacetone alcohol, furfuryl alcohol, benzyl alcohol, diethylene glycol monoethyl ether and oxyethyl phenyl ether is usable additionally to the water.

The near-infrared ray absorbing layer coating liquid and the protective layer coating liquid are preferably coated on the support by a slide bead coater. It is preferable that the coating of the near-infrared ray absorbing layer coating liquid and the protective layer coating liquid is performed while flowing a liquid containing no latex on the sliding surface of the slide bead coater along a coating width regulating plate of the coater. It is also preferable that ate least two kinds of coating liquid and a liquid containing no latex were initially flown in layers on the sliding surface of the coater so that the flowing amounts of the liquids are made constant and then the liquid containing no latex is stopped and the coating liquids are coated on the support. In such the case, the viscosity of the liquid containing no latex is preferably lower than that of the coating liquid and the surface tension of the liquid containing no latex is preferably lower than that of the uppermost layer coating liquid.

In the present invention, it is preferable that the near-infrared ray absorbing layer coating liquid and the protective layer coating liquid are simultaneously coated on the support and then dried at a wind velocity on the surface of the coated layer of from 0.5 to 10 m/second in the period of not more than ½ of the period of from just after the coating to beginning of the constant-rate drying period. The near-infrared ray absorbing material of the present invention is preferably dried according to the drying theory in the chemical industry. The method for giving moisture on the occasion of the drying should be suitably selected. Excessively high drying rate tends to cause deterioration in the properties by occurrence of reticulation and lowering in the durability. The near-infrared ray absorbing material of the present invention is preferably dried for a time of from 10 second to 20 minutes at a relative humidity of not more than 20% and a temperature of from 30° C. to 90° C. and, and more preferably for a time of from 50 to 50 seconds at a temperature of form 35° C. to 50° C. Particularly, the temperature and humidity are decided so that the constant-rate drying and the falling-rate drying are preferably controlled. The constant-rate drying is a process in which the near-infrared ray absorbing material is dried while the moisture is evaporated from the surface of the material. The surface temperature of the material is constant in such the process; therefore the process is called constant-rate drying. In the next process, the moisture is evaporated from the interior of the near-infrared ray absorbing material. Consequently, the wet-bulb temperature nears and finally meets with the surface temperature of the near-infrared ray absorbing layer or the dry-bulb temperature, therefore such the process is called falling-rate drying. In the drying of gelatin layer, a point at which the layer contains water of from 300 to 400 times by weight of gelatin is the border of the constant-rate drying and the falling-rate drying. The conditions for drying the layer with a moisture content of not more than 300 times are important in the falling-rate drying process. The production efficiency is raised when the drying process is carried out at a higher temperature and a lower humidity. It is preferable, therefore, that the properties of the material are not varied or lowered by drying under such the conditions. The period of the moisture content of the drying layer of from 70 to 3% by weight of the dried weight corresponds to a later period of the drying since the limit moisture content of the constant-rate drying period is about 300% of the dried weight. It is desirable to control the conditions of the drying after becoming the moisture content to 70% because the shrink of the coated layer begins abut such the moisture content. In the period of the moisture content of from 70 to 3% by weight, reticulation caused by distortion of the coated layer formed by rapidly and ununiformly shrinking of the layer or adhesion of the layer caused by moisture remaining in inner portion of the layer are caused by drying only at the surface of the coated layer depending on the drying conditions. It is preferable, therefore, that the drying is carried out under conditions of a dew point of from 10° C. to 33° C., a relative humidity of from 35% to 85% and a dry-bulb temperature of not more than 36° C. Though the drying conditions within the above range are finally decided according to the Latex/gelatin ratio and the rate of air blowing to the coated layer, more preferable range of the condition is a dry-bulb temperature of from 25° C. to 34° C., a relative humidity of from 55% to 75% and a highest dew point of not less than 33° C., and the optimum condition is a dry-bulb temperature of from 26° C. to 30° C. and a relative humidity of from 60% to 75%. A dew point of not more than 10° C. is not suitable for practical use because the drying efficiency is lowered. The drying is accelerated by lowering of the relative humidity and a relative humidity of not less than 85% considerably retards the drying rate and poses possibility of occurrence of adhesion. On the other hand, rising in the dry-bulb temperature increases drying rate and a dry-bulb temperature of not less than 36° C. causes exceedingly drying at the surface of the coated layer and the moisture can be reduced but such the condition is not desirable regarding the dimensional stability of the support. Therefore, the dry-bulb temperature is preferably set at a temperature of not more than 70° C. The drying rate is largely influenced by the blowing rate of the drying air against to the material to be dried, therefore, a velocity of drying air of not more than 100 m/second and a distance between the material to be dried and opening for blowing air of not less than 100 mm are preferable. In more preferable conditions, the velocity of drying air is not more than 50 m/second and the distance is not less than 30 mm.

The producing process is preferably performed in an environment of not more than cleanness degree of U.S. Standard 209d class 10,000 because dust contamination in the production processes of coating, drying, cutting and packaging deteriorates the quality of the product of the present invention. The U.S. Standard 209d class is a standard on clean room, and the environment of U.S. Standard 209d 10,000 class is an environment in which the aggregate number of particles having a particle size of not more than 5 μm is not more than 10,000/ft³ and that of particles having a particle size of not less than 5.0 μm is not more than 65. The number of dust particle is preferably near 0 such as that in the cosmic space, but suitable cleanness should be selected because the production in a super clean room requires high cost. It is not limited to attach cover film of 20 to 60 μm, which is peeled off on the occasion of the use, on the near-infrared ray absorbing material for preventing occurrence of contaminations and damages. However, it is economically advantageous to use no peeling film since peeled film should be disposed as unnecessary material occurs.

The material of the present invention after the coating can be progressed in the crosslinking degree and prevented in the curling so as to easily passed onto the front panel of PDP by seasoning for 1 day or more under conditions of a temperature of from 10 to 60° C. and a relative humidity of from 40 to 80% in the rolled state and rewound so that the near-infrared ray absorbing layer is outside and packed on the occasion of shipping. The seasoning condition can be suitably selected. For example, the seasoning conditions such as for 3 days at 30° C. and a relative humidity of 50% and 2 days at 35° C. and a relative humidity of 40% can be optionally selected without any limitation.

Support

In the present invention, a plastic film, a plastic plate, and glass plate are usable for the support. As the material of the plastic film and plate, for example, polyesters such as poly(ethylene phthalate) (PET) and poly(ethylene naphthalate) (PEN), vinyl polymers such as polystyrene (PE), polypropylene (PP) and polystyrene, polycarbonate (PC) and triacetyl cellulose (TAC) are usable.

The plastic film is preferably the films of PE, PEN and TAC from the viewpoint of the transparency, thermo-resistivity and handling easiness.

The support having high transparency is preferably preferred because high transparency is required to the near-infrared ray absorbing material. In such the case, the whole visible light transmittance of the plastic film or the plastic plate is preferably from 80 to 100% and more preferably from 90 to 100%. The plastic film or plate tinted in a degree as long as it does not disturb the object of the present invention may be used for controlling the tone.

Solvent for Preparing Coating Liquid

Water, an organic solvent, for example, an alcohol such as methanol and ethanol, a ketone such as acetone, methyl ethyl ketone and methyl iso-butyl ketone, an amide such as formamide, a sulfoxide such as dimethylsulfoxide, an ester such as ethyl acetate, an ether, an ionic liquid and a mixture thereof are usable as the solvent for the near-infrared ray absorbing dye of the present invention though the solvent is specifically limited. The dye dissolved in a solvent may be dispersed in water to form fine droplets. The dispersion of fine oil droplet having a diameter of not more than 10 μm is called fine oil droplet dispersion. The diameter of the fine oil droplet can be measured by an optical microscope or a diffraction pattern of laser light beam by the droplets. A method is also preferably applied in which a near-infrared ray absorbing dye substantially insoluble in water is added to the latex in the form of fine oil droplet dispersion. Any organic solvent may be used for preparing the fine oil droplet dispersion of the near-infrared ray absorbing dye, and benzene, toluene, xylene, benzyl alcohol, phenetyl alcohol, pyridine, phenoxyethanol and chloroform can be exemplified in concrete. Benzyl alcohol, phenetyl alcohol and phenoxyethanol are preferable, and benzyl alcohol and phenoxyethanol are more preferable. Various type dispersing machines can be effectively employed for dispersing a concentrated solution of the near-infrared ray absorbing dye into water. A high speed stirrer, an attriter and a ultrasonic dispersing apparatus are concretely usable. A surfactant can be used on the occasion of finely dispersing the concentrated solution of the near-infrared ray absorbing dye in water. The temperature for dispersing the concentrated solution of the near-infrared ray absorbing dye is from 0 to 100° C., preferably from 20 to 80° C., and more preferably from 40 to 80° C. The oil droplet dispersion of the near-infrared ray absorbing dye may be mixed with a water-soluble polymer for providing a ant-precipitation ability, the mixture is stored for long period at a temperature of not more than 30° C. or in a refrigerator.

The thickness of the near-infrared ray absorbing material of the present invention is preferably from 5 to 200 μm and more preferably from 30 to 150 μm. The material having the thickness of from 5 to 200 μm gives desired visible light transparency and is easily handled.

In the present invention, a functional layer can be separately provided. The functional layer may have various specifications according to the purpose of the layer. For example, an anti-reflection layer having anti-reflection function given by controlling the refractive index and the layer thickness, a non-glare or an anti-glare layer each having a ability for preventing the glare, a layer having a tone control function absorbing a specified wavelength region of visible light, a anti-staining layer having the surface from which staining such as finger print can be easily removed, a hard coating layer difficultly be damaged, a shock absorbing layer and a layer having an ability of preventing the scatter of broken pieces of glass when the glass is broken may be provided for an electromagnetic wave shielding material.

These functional layers may be directly pasted onto the PDP or onto a transparent substrate such as a glass plate and an acryl resin plate separately from the body of the plasma display panel. These functional panels may be called optical filter or simply a filter.

The anti-reflection layer having reflection preventing ability is constituted by single or piled layers of an inorganic compound such as an oxide, fluoride, silicide, boride, carbide, nitride and sulfide of metal formed by a method such as a vacuum deposition method, a spattering method, an ion plating method or an ion beam assist method, or constituted by single or piled layers of resins each different in the refractive index thereof such as an acryl resin and a fluoro-resin. Moreover, a film subjected to a reflection preventing treatment can be pasted on the filter. It is arrows to past a film subjected to a non-glare or anti-glare treatment. A hard coat layer may be provided according to necessity.

The tone controlling layer having a color compensating ability which is capable of absorbing a specified wavelength region of visible light is provided as a means for resolving a problem that a blue image is expressed by purplish blue color because the blue light emitting phosphor of the DPD emits a little red light, and contains a dye absorbing light near 595 nm. Concrete examples of such the dye absorbing the specified wavelength include known inorganic pigments and organic pigments and dyes such as ones of azo type, condensed azo type, phthalocyanine type, anthraquinone type indigo type, perinone type, perylene type, dioxane type, quinacridone type, methine type, isoindolinone type, quinophthalone, pyrrol type, thioindigo type and a metal complex type. Among them the phthalocyanine type and the anthraquinone type dyes are particularly preferred, which are superior in the weather resistance.

An adhesive having a high transparency is suitable for pasting the near-infrared ray absorbing material of the present invention to the PDP. For example, adhesives of vinyl acetate type, epoxy type, urethane type, ethylene-vinyl acetate type, urethane-acrylate type and epoxy-acrylate type are preferable. Among them, transparent and colorless adhesives of epoxy-acrylate type and ethylene-vinyl acetate type are more preferable. For giving the anti-reflection ability to the transparent film relating to the present invention, a liquid may be coated on the transparent film, which contains a transparent printing ink composed of particles of silica, tine oxide or titanium oxide and an acryl resin, a styrene resin or a polyester resin each dispersed or dissolved in an organic solvent such as an aromatic hydrocarbon such as toluene, a glycol ether and a propylene glycol. The average diameter of the particles is preferably from 0.01 to 10 μm, and a mixture of particles different from each other in the particle diameter is more preferable. The effect of such the layer is to reduce the apparent reflection by diffusely reflecting the light by making an irregular surface. A method is applicable in which a transparent thin layer is provided on a transparent film for reducing the reflection by utilizing the reflection and refraction of light at the interface of the thin layer. Namely, the method utilizes the principles that the phase of the light reflected at the upper surface and that of the light reflected at lower surface are shifted so that the light is set off by the interference when the thickness of the thin layer is λ/4, λ is the wavelength of light and the intensity of the synthesized light is lowered and the reflection of light is made lowest when the nf is equal nb^{1/2}, in which nf is refractive index of the material of the thin layer and nb is that of the support for forming the thin layer. Consequently, the objective thickness of the thin layer is ¼ of the wavelength of the light to be preventing the reflection. Namely, the thickness of the thin layer is 0.05 to 0.25 μm. When a thin layer 2 is further provided between the thin layer 1 and the transparent film, the refractive index of the thin layer 2 is related to the reflection and the reflection can be prevented based on the above calculation in which the refractive index of the thin layer 2 is used as nb. In practice, though any combination completely satisfying the above conditions is hardly obtained, it is necessary that the refractive index of the material of the thin layer is as lower as possible than that of the transparent film, and the use of a fluororesin having a refractive index of from 1.28 to 1.45 is preferable. In the case of the trans parent film is poly(ethylene terephthalate), the above example is suitable since the refractive index of the PET is 1.64. The refractive index of the cellulose triacetate is 1.5. Accordingly, when the thin layer of the fluororesin is used, a layer of diallyl phthalate having a refractive index of 1.59, a layer of thin oxide having a refractive index of 2.00 or a layer of a mixture having a refractive index of 1.59 prepared by tin oxide and an acryl resin having a refractive index of 1.49 is preferably provided between the tranceparent film and the thin layer.

A surfactant is preferably coated for giving anti-static ability to the film. It is also preferable to coat a printing ink containing a transparent electroconductive substance such as tin oxide, titanium oxide or ITO, or to provide a thin layer such the transparent electroconductive substance by spattering. It is more preferable to provide the fluororesin layer after provision of the transparent electroconductive substance layer or coating the printing ink containing tin oxide to the transparent film, according to necessity. Both of the anti-static ability and anti-reflection ability can be given to the transparent film by such the treatment. The electroconductivity at the surface is important and the surface conductivity of from 10⁶ to 10¹² Ω/□ is preferable.

### EXAMPLES

The present invention is more concretely described below referring examples. The materials, using amount and ratio thereof, treatment and treatment procedure described in the examples can be optionally varied as long as not to deviate from the purpose of the present invention. Consequently, the scope of the present invention is not limited by the following examples.

### Example 1

Preparation of Aqueous Dispersion of Thermoplastic Resin

Aqueous Dispersion of Acryl Resin AL

Into a three-mouth flask of 0.5 L, 300 g of deionized water, 25 g of methyl methacrylate (MMA), 25 g of styrene, 45 g of ethyl acrylate (EA), 5 g of hydroxyethyl methacrylate (HEMA) and 250 mg of ammonium persulfate were charged and stirred for 3 hours at 100° C. while bubbling by nitrogen gas. After completion of reaction, 100 mg of hydroquinone was added to prepare an aqueous dispersion of thermoplastic resin AL.

Aqueous dispersion of styrene-butadiene resin SB

Into a three-mouth flask of 0.5 L, 300 g of deionized water, 48 g of butadiene, 40 g of styrene, 12 g of itaconic acid, 2 g of acrylic acid, 1 g of anionic emulsifier and 6 g of ammonium persulfate were charged and stirred for 30 minutes at 25° C., and then the mixture was heated by 60° C. and polymerized for 3 hours after addition of 2 g of sodium bisulfite.

Aqueous Dispersion of Styrene-Isoprene Resin SI

Into a three-mouth flask of 1 L, 300 g of deionized water, 40 g of isoprene, 48 g of styrene, 12 g of itaconic acid, 2 g of acrylic acid, 1 g of anionic emulsifier and 6 g of ammonium persulfate were charged and stirred for 30 minutes at 25° C., and then the mixture was heated by 60° C. and polymerized for 3 hours after addition of 2 g of sodium bisulfite.

Into a three-mouth flask of 1 L, 80 g of particles of poly(vinyl alcohol) having a polymerization degree of 1,500, saponification value of 99.5 mole % and 300 g of pure water were charged and heated by 95° C. After dissolution of poly(vinyl alcohol), the temperature of the solution was lowered by 75° C. To the resultant solution, 3 g of a 10% by weight solution of hydrochloric acid, 20 g of butyl aldehyde were added and reacted. The reaction was progressed under reflux for preventing evaporation and flow out of the aldehyde. After that 90 g of the 10% by weight solution of hydrochloric acid was added as additional catalyst and the reacting system was held at 82° C. for 4 hours. After completion of the reaction, the liquid was cooled by 40° C. and neutralized by sodium bicarbonate at room temperature. Thus prepared resin was washed by water and dried. One hundred grams of the resin was dispersed in 300 g of a 15% aqueous solution of isopropanol.

Aqueous Dispersion of Vinyl Acetate VA

Into a stainless flask of 1 L, 300 g of water, 100 g of vinyl acetate and 1 g of anionic emulsifier were charged. The resultant dispersion was heated by 85° C. and 3 g of potassium persulfate was added after 30 minutes, and then emulsion polymerized at 85° C. for 3 hours.

Aqueous Dispersion of Urethane Resin UN

Into a 1 L reaction vessel, 70 g of poly(tetramethylene ether glycol) having a number average molecular weight of 2,000 was charged and heated at 100° C. for 1 hour and then cooled by 85° C. And then 32 g of isophoron diisocyanate was added and reacted for 3 hours at 85° C. Thus 102 g of urethane polymer was obtained. The polyurethane was dissolved in isopropyl alcohol and then 300 g of water was added at 40° C. and dispersed while stirring so as to obtain an aqueous dispersion of urethane resin UN.

Preparation of Near-Infrared Ray Absorbing Material

A 175 μm transparent biaxially stretched poly(ethylene terephthalate) film was treated by corona discharge of 100 W/m²·minute on both sides, and a latex, LX407C5 manufactured by Nihon Zeon Co., Ltd., composed of styrene-butadiene copolymer having a refractive index of 1.55, an elastic modulus at 25° C. of 100 MPa and a glass transition point of 37° C. was coated on both sides of the film to form a subbing layer having a thickness of 300 μm. An acryl type latex, HA16 manufactured by Nihon Acryl Co., Ltd., having a refractive index of 1.50, an elastic modulus at 25° C. of 120 MPa and a glass transition point of 50° C. was coated on the subbing layer to form a second subbing layer having a dry thickness of 80 nm. In the second subbing layer, particles of 12 nm of tin oxide doped with 3% of indium and particles of 15 nm of zinc oxide doped with 4% of gallium were contained in an amount of 30 mg/m² as anti-static agents for providing anti-static ability to the film. On the second subbing layer, a near-infrared ray absorbing layer containing the near-infrared ray absorbing dye shown in Table 1 (coating amount: 1×10⁻⁴ moles/m²), the UV absorbent shown in Table 1 (coating amount: 1×10⁻⁴ moles/m²), the aqueous dispersion of thermoplastic resin dispersion shown in Table 1 (3 g/m²), gelatin (1 g/m²) and tricresyl phosphate was simultaneously coated together with the following gelatin protective layer and dried. Thus a near-infrared ray absorbing layer was prepared.

In the near-infrared ray absorbing layer coating liquid, the concentration of the organic solvent of isopropyl alcohol and the concentration of the resin solid content were each controlled so as to be 5% by weight and 20%, respectively. The whole amount of the binders was the total amount of the resin (J), gelatin (G) and tricresyl phosphate (L), and the value of S=J/(J+G+L) was varied.

The surface tension of the near-infrared ray absorbing layer coating liquid was adjusted to 360±20 μN/cm by adding a fluorosurfactant of diperfluorohexylsulfosuccinate.

The near-infrared ray absorbing dye was dispersed by solution dispersing using chloroform as solvent or by solid dispersing. The solid dispersion was carried out by a planet ball mill prepared by partially stabilized zirconia, manufactured by Ito Seisakusho Co., Ltd, In a vessel of 200 ml of the mill, 100 ml of water, 10 g of the near-infrared ray absorbing dye and 30 ml of beads having a diameter 2 mm were charged and the mill was worked at room temperature. The desired average diameter was obtained by varying the accumulative number of dispersing of the ball mill within the range of from 100 hours to 200 hours. The phosphate-gelatin dispersion was prepared by adding 4 g of tricresyl phosphate, 50 ml of ethyl acetate and 0.2 g of surfactant (an adduct of lauryl alcohol and polyethylene glycol having a polymerization degree of 10) to 50 ml of a 4% by weight aqueous solution of gelatin and dispersing by ultrasonic wave. The diameter of the dispersed particle was measured by Coulter Counter Multisizer II manufactured by Beckman Coulter Inc. Thus dispersed particles were added to the foregoing aqueous dispersion of thermoplastic resin or phosphate-gelatin dispersion.

As crosslinking agent, glyoxal, bis-1,3-(vinylsulfone)-2-hydroxypropane, a condensate of epichlorohydrine and bisphenol A, diethylaminoethyltriethoxysilane and sodium 2,4-dichloro-6-hydroxy-1,3,5-triazine were added each in an amount of 0.2 millimoles per gram of gelatin was added to the coating liquid. As the slipping agent, carbanau wax, behenic amide and lauryl behenate were added each in an amount of 0.3%. The pH of the coating liquid was adjusted to 5.6 by sodium hydroxide.

The protective layer of the near-infrared ray absorbing layer was formed by coating the following coating liquid so that the coated amount of gelatin was 0.6 g/m². The coating liquid of the protective layer was prepared by the following procedures; 1 g of a fluorosurfactant of diperfluorohexyl succinate was added to 1 L of a 10% aqueous solution of lime process gelatin so as to make the surface tension of the solution to 31 dyn/cm. To the resultant solution, 2 g and 1 g of poly(methyl methacrylate) particles having each an average diameter of 3 μm and 5 μm, respectively, as the matting agent, 1 g of the slipping agent of lauryl behenate, an aqueous dispersion of copolymer of styrene/methyl methacrylate/ethyl acrylate/acrylic acid/acrylamidemethylpropyl sulfonate (monomer ratio of 25:25:20:20:3) having a solid content of 30% by weight, 3 g of the UV absorbent of 6-(2-benzotriazolyl)-4-t-octyl-6′-t-butyl-4′-methyl-2,2′-methylenebisphenol, and 2 millimoles pre gram of gelatin of the crosslinking agent of 1,3-bis(vinylsulfonamide)-2-hydroxypropane were added.

The near-infrared ray absorbing layer and the protective layer were simultaneously coated in a rate of 200 m/minute by a slide coater and the drying time until the falling-rate drying was set for not more than 2 minutes. The air blowing rate on the coated layer was set at 2/s during not more than ½ the period of from just after the coating to the completion of the constant rate drying. The filtration of the coating liquid was carried out by three-step filtration using seriously connected three filters each having a pore size of 3 μm, 10 μm and 30 μm. The coating, drying, cutting and packaging of the samples were performed in a environment of not more than U.S. Standard 209d class 10,000.

An anti-reflection layer and a hard coat layer were coated on the surface of the support opposite to the near-infrared ray absorbing layer. These layers were coated according to the following receipts after preparation of Sample 103. The anti-halation layer and the hard coat layer did not disturb the properties of the near-infrared ray absorbing layer.

Hard Coat Layer

A coating material of hard coat layer composed of 25.0 parts by weight of a UV curable acryl resin Aronix UV-3700 manufactured by Toa Gousei Co., Ltd., 8.0 parts by weight of tin oxide doped with indium having a particle diameter of from 0.2 to 2.0 μm, 24.0 parts by weight of methyl ethyl ketone and 33.0 parts by weight of toluene was coated by Mayer bar and irradiated by UV using a high pressure mercury lamp for 1 to 20 second to form the hard coat layer coated film.

Anti-Reflection Layer

On the high refractive hard coat layer, the foregoing low refractive layer coating liquid was coated so that the dry layer thickness was 100 μm and subjected to heat treatment at 120° C. for 1 hour. Thus near-infrared ray absorbing materials 100 to 122 were prepared, in which the refractive index of the low refractive layer was 1.42. The obtained near-infrared ray absorbing materials each have a whole visible light transmittance of 94.0%, a haze value of 0.5 and the lowest reflectivity at the visible wavelength of 0.5. The materials were superior in the anti-reflection ability.

The coated samples were each leaved for 3 days in a room controlled at 25° C. and relative humidity 42% before the accelerated aging test and then enclosed in a sealable bag composed of aluminum foil and carbon black-containing 40 μm polyethylene sheet. The moisture permeation ratio and the oxygen permeation ratio of the bag were less than 0.01 g/m²·day and less than 0.01 ml/m²·day, respectively. The moisture permeation ratio can be measured by a method according to JIS K7129-1992, mainly MOCON method, and the oxygen permeation ratio can be measured by a method according to JIS K-7126-1987, mainly MOCON method. The dynamic frictional coefficient of the outermost surface of the protective layer measured by a dynamic frictional coefficient meter manufactured by Orientec Co., Ltd., was within the range of from 0.2 to 0.4. The surface resistance was with in the range of from 10⁸ to 10¹⁰ Ω/□. The surface resistance was measured by measured by a method according to JIS C-6481 by applying a voltage of 100 V. The hardness of the surface of the protective layer was within the range of from 2H to 3H by pencil harness. The pencil harness was measured by Heidon 14 manufacture by Shintou Kagaku Sha Co., Ltd., according to the pencil scratching test method of JIS B-0601. The Ra of the outermost surface of the protective layer was within the range of from 2 to 3 μm. The measurement was carried out by Surficorder SE-3C manufactured by Kosaka Kenkyu Sha Co., Ltd., according to the surface roughness measuring method of JIS B-0601.

Evaluation of Equilibrium Moisture Content

The coating solution or dispersion of the binder used in the near-infrared ray absorbing layer was coated on a glass plate and dried for 1 hour at 50° C. for preparing a thin layer resin of 100 μm. Then the resin layer was peeled off from the glass plate and stood for 3 days under a condition of 25° C. and 50% of RH, and the moisture content W₁ of the layer was measured by a Karl-Fischer aquameter MKC-510 manufactured by Kyoto Denshi Kogyo Co., Ltd. After that, the resin layer was leaved for 3 days in a vacuum environment and the moisture content W₀ in the same manner the same as above. The equilibrium was calculated using W₁ and W₀ according to the following expression.
Equilibrium moisture content={(W₁−W₀)/W₀}×100%

Evaluation of Deterioration by Aging

The deterioration by aging of the above layer was evaluated by the variation ratios in percent of the average visible light transmittance of visible light at 400 to 750 nm and the average absorptance of near-infrared at 800 to 1,000 nm measured before and after standing for 200 hours under a condition of a temperature of 70° C. and a relative humidity of 90%. The constitutions of the samples and the evaluated results are listed in Table 1. The light deterioration was evaluated by deterioration ratio of the absorbance of the sample before and after standing for 100 hours under the condition of a relative humidity of 50% and an intensity of irradiation light of 50 W/m² using Super Xenon Weather Meter SX75 manufactured by Gas Shikenki Co., Ltd.

TABLE 1

| | Contents of near-infrared ray absorbing | | | | | | | | | | | | | | |
|---|---|---|---|---|---|---|---|---|---|---|---|---|---|---|---|
| | dye layer | | | | | | | | | | | | | | |
| Sample | | UV | Resin | Resin | | | *8 | | *6 | | *8 | | *6 | | |
| No. | *1 | absorbing dye | dispersion | ratio S | *2 | *3 | *4 | *5 | *4 | *5 | *9 | *7 | *9 | *7 | Remarks |
| 100 | S-7 | None | None | 0 | 0 | 4 | 98 | 88 | 98 | 87 | 99 | 66 | 98 | 85 | Comparative |
| 101 | S-7 | None | SB | 27 | 5 | 2 | 98 | 92 | 98 | 92 | 99 | 86 | 98 | 86 | Inventive |
| 102 | S-7 | None | SB | 32 | 5 | 2 | 98 | 94 | 98 | 94 | 99 | 87 | 98 | 87 | Inventive |
| 103 | S-7 | None | SB | 40 | 5 | 0.6 | 98 | 96 | 98 | 96 | 99 | 88 | 98 | 88 | Inventive |
| 104 | S-7 | None | SB | 60 | 5 | 0.15 | 98 | 97 | 98 | 97 | 99 | 90 | 98 | 90 | Inventive |
| 105 | S-7 | None | SB | 90 | 5 | 0.02 | 98 | 98 | 98 | 98 | 99 | 92 | 98 | 92 | Inventive |
| 106 | S-7 | None | SB | 100 | 5 | 0.01 | 98 | 98 | 98 | 98 | 99 | 92 | 98 | 92 | Inventive |
| 107 | S-7 | U-1 | SB | 27 | 5 | 2 | 98 | 92 | 98 | 92 | 99 | 90 | 98 | 90 | Inventive |
| 108 | S-7 | U-1 | SB | 32 | 5 | 2 | 98 | 94 | 98 | 94 | 99 | 92 | 98 | 92 | Inventive |
| 109 | S-7 | U-1 | SB | 40 | 5 | 0.6 | 98 | 96 | 98 | 96 | 99 | 94 | 98 | 94 | Inventive |
| 110 | S-7 | U-1 | SB | 60 | 5 | 0.15 | 98 | 97 | 98 | 97 | 99 | 96 | 98 | 96 | Inventive |
| 111 | S-7 | U-1 | SB | 90 | 5 | 0.02 | 98 | 98 | 98 | 98 | 99 | 98 | 98 | 98 | Inventive |
| 112 | S-7 | U-1 | SB | 100 | 5 | 0.01 | 98 | 98 | 98 | 98 | 99 | 99 | 98 | 99 | Inventive |
| 113 | S-7 | U-1 | AL | 100 | 0 | 0.01 | 98 | 98 | 98 | 98 | 99 | 99 | 98 | 99 | Inventive |
| 114 | S-7 | U-1 | VB | 100 | 0 | 0.01 | 98 | 98 | 98 | 98 | 99 | 99 | 98 | 99 | Inventive |
| 115 | S-7 | U-1 | VA | 100 | 0 | 0.01 | 98 | 98 | 98 | 98 | 99 | 99 | 98 | 99 | Inventive |
| 116 | S-7 | U-1 | UN | 100 | 0 | 0.01 | 98 | 98 | 98 | 98 | 99 | 99 | 98 | 99 | Inventive |
| 117 | S-7 | U-1 | SB | 100 | 20 | 0.01 | 98 | 98 | 98 | 98 | 99 | 99 | 98 | 99 | Inventive |
| 118 | S-7 | U-1 | VA | 100 | 30 | 0.01 | 98 | 92 | 98 | 90 | 99 | 91 | 98 | 90 | Inventive |
| 119 | S-7 | U-1 | UN | 100 | 40 | 0.01 | 98 | 87 | 98 | 86 | 99 | 88 | 98 | 89 | Inventive |
| 120 | P-1 | U-1 | SI | 100 | 40 | 0.01 | 98 | 87 | 98 | 86 | 99 | 88 | 98 | 89 | Inventive |
| 121 | q-6 | U-4 | SI | 100 | 40 | 0.01 | 98 | 87 | 98 | 86 | 99 | 88 | 98 | 89 | Inventive |
| 122 | S-2 | U-6 | SI | 100 | 40 | 0.01 | 98 | 87 | 98 | 86 | 99 | 88 | 98 | 89 | Inventive |

*1: Near-infrared ray absorbing dye,
*2: Solvent ratio in coating liquid
*3: Equilibrium moisture content %,
*4: Before treatment under 70° C. and 90% RH
*5: After treatment under 70° C. and 90% RH,
*6: Absorptance at 800 to 1000 nm
*7: After UV irradiation,
*8: Transmittance at 400 to 750 nm,
*9: Before UV irradiation

As above-described, the near-infrared ray absorbing material having high visible light transmittance and high near-infrared ray absorbance, and small in the deterioration of the near-infrared absorbance during the storing under high temperature and in the deterioration by light can be obtained by the present invention.

What is claimed is:

1. A method of producing a near-infrared ray absorbing material comprising the steps of:
applying a coating liquid of a near-infrared ray absorbing layer comprising a near-infrared ray absorbing dye and a latex onto a support to form a coated layer; and
drying the coated layer by heat to form the near-infrared ray absorbing layer,
wherein the near-infrared ray absorbing layer absorbs not less than 60% of a total amount of near-infrared rays having wavelengths of 800 to 1000 nm.

2. The method of claim 1, wherein the near-infrared ray absorbing layer absorbs not less than 80% of the total amount of near-infrared rays having wavelengths of 800 to 1000 nm.

3. The method of claim 1, wherein the latex is selected from the group consisting of an acryl resin, a styrene resin, a urethane resin and a vinyl resin.

4. The method of claim 1, wherein the coating liquid comprises:
a solvent containing water in an amount of not less than 30 weight % based on the total weight of the solvent; and
a binder containing a latex in an amount of not less than 30 weight % based on the total weight of the binder,
wherein an equilibrium moisture content in the binder is not more than 3% by weight at a condition of 25° C. and 55% relative humidity.

5. The method of claim 1, wherein the coating liquid comprises:
a solvent containing water in an amount of not less than 30 weight % based on the total weight of the solvent; and
a binder containing a latex in an amount of not less than 60 weight % based on the total weight of the binder,
wherein an equilibrium moisture content in the binder is not more than 1 weight % at a condition of 25° C. and 55% relative humidity.

6. The method of claim 1, wherein the near-infrared ray absorbing material comprises a near-infrared ray absorbing dye selected from the group consisting of a diimmonium compound, a nickel dithiol compound, a phthalocyanine compound and a squalium compound.

7. The method of claim 6, wherein the near-infrared ray absorbing dye is the squalium compound.

8. A near-infrared ray absorbing material produced by the method of claim 1.

9. The near-infrared ray absorbing material of claim 8, wherein
the near-infrared ray absorbing material comprises 2 or more constitution layers; and
one of the constituting layers comprises a UV absorbent.

10. The near-infrared ray absorbing material of claim 9, wherein
a bottom layer of the constitution layers is an antistatic layer comprising a metal oxide; and
a surface resistance of the antistatic layer is 10⁶ to 10¹² ohm/sq.

11. The near-infrared ray absorbing material of claim 8, wherein
the near-infrared ray absorbing material has a function layer on a surface of the support opposite to the surface on which the near-infrared ray absorbing layer is provided; and
the function layer is selected from the group consisting of an antireflection layer, a hard coat layer, an adhesive layer and an electromagnetic radiation absorbing layer.
